(19) United States
(12) Patent Application Publication
(10) Pub. No.: US 2018/0314790 A1
(43) Pub. Date: Nov. 1, 2018

(54) System, Method and Apparatus for Determining the Effect of Genetic Variants

(71) Applicant: METABOLON, INC., Durham, NC (US)

(72) Inventors: Shaun Lonergan, Morrisville, NC (US); John A. Ryals, Chapel Hill, NC (US); Michael V Milburn, Apex, NC (US); Adam Kennedy, Durham, NC (US); Lining Guo, Chapel Hill, NC (US); Kay A Lawton, Raleigh, NC (US)

(21) Appl. No.: 15/523,854

(22) PCT Filed: Nov. 4, 2015
(86) PCT No.: PCT/US15/58934

§ 371 Date: May 2, 2017

Related U.S. Application Data
(60) Provisional application No. 62/075,949, filed on Nov. 6, 2014.
(60) Provisional application No. 62/075,449, filed on Nov. 5, 2014.

(51) Int. Cl. G06F 19/18

(52) U.S. Cl. CPC G06F 19/18

(57) ABSTRACT

Methods using a combination of metabolomics and computer technology to determine sequence variants with potential negative or detrimental effects and enable the classification of a variant with an unknown or uncertain clinical significance from VUS status to benign, pathogenic or advantageous are described. For example, methods of using metabolomics to expedite personalized medicine based on genomic sequence analysis are described. Using metabolic profiles to determine (or aid in determining) the significance of genetic variants and enable the identification of diagnostic variants (those variants having a detrimental health affect) for use in personalized medicine is described. Further, using metabolic profiles to determine the presence of advantageous variants that may have a positive effect on patient health is also described.

### CROSS-REFERENCE TO RELATED APPLICATIONS

This application claims the benefit of U.S. Provisional Patent Application No. 62/075,449, filed Nov. 5, 2014, and U.S. Provisional Patent Application No. 62/075,949, filed Nov. 6, 2014, the entire contents of which are hereby incorporated herein by reference.

### BACKGROUND

Genomic sequence methods-whole exome sequencing and whole genome sequencing have revealed many DNA sequence variations (i.e., polymorphisms). These genetic variations include single nucleotide polymorphisms (SNPs), and structural variations such as inserts/deletions (Indels), copy number variants (CNVs), transpositions, sequence rearrangements. Genome wide association studies (GWAS) have been performed to uncover associations between SNPs and human disease and many traits. However, the focus of GWA studies has been primarily on common variants and the studies have succeeded in determining the significance of only a small number of genetic components of common human diseases.

So-called “next generation sequencing” of whole genomes was expected to rapidly facilitate identification of the genetic basis of disease and various human traits. To date, whole genome sequencing has revealed more genetic variants (>1M variants have been uncovered). However, the association with disease or other phenotypes and the significance of many genetic variants have yet to be determined. To date, proper interpretation of these numerous variants is challenging for clinicians

Variants determined by sequencing methods are classified as “Deleterious”, which is highly pathogenic; “Likely Pathogenic”; “Variant of Uncertain Clinical Significance” (VUS), which is indeterminate; “Likely Not Pathogenic”; and “Not Pathogenic” or “No Clinical Significance” [Plon, S E. Hum Mutat. 2008 November; 29(11): 1282-1291]. Patients in the middle (VUS) category generally do not receive additional testing or follow-up observations, leading to patient uncertainty as to the status of their condition. Additional data for all variant categories would help to more accurately assess the clinical significance of genetic variants.

Variants due to an insertion or deletion may cause a frame shift in the amino acid sequence of the protein resulting in structural alterations (e.g., protein truncation, mis-folding, etc.) that in turn lead changes in or inactivation of protein function. These types of variants may be classified using functional assays. Mis-sense mutations in coding regions of protein may be interpretable by sequence analysis, especially if present in well conserved functional domains of protein. However, this information is not available for every protein, and not all proteins have functional assays. Computational algorithms and databases (e.g., SIFT, PolyPhen, Align GVGD, Grantham score, Mutation Taster) for predicting and prioritizing functional pathogenic variants exist, but they are not yet fully effective. Further, the pathological effect of variants in non-coding sequences (e.g., exon-intron boundaries, 5′ and 3′ non-transcribed regions, 5′ and 3′ non-translated regions, regulatory sequences such as promoters, termination sequences, etc.) and small in-frame insertions and deletion and nucleotide substitutions that do not result in an amino acid change are difficult to assess.

Current approaches for evaluating the clinical relevance of genetic variants, particularly VUS, require integrated studies such as co-segregation of VUS with disease, concurrence with deleterious trans mutations, personal and family health history of the carrier, in silico assessment of phylogenetic conservation and severity of the protein modification in biochemical functional assays. However, using these methods, it is challenging to assess the significance of large numbers of variants because analysis is often done on an individual protein-by-protein basis or sequence-by-sequence basis vs. “batch” analysis. The need exists to have more information available relating to genetic variants.

Metabolomics has been increasingly recognized as a powerful phenotyping tool that accounts for the impacts from genetics, environment, microbiota, and xenobiotics. Metabolites represent intermediate biological processes that bridge gene function, non-genetic factors, and phenotypic endpoints. Thus, the analysis of metabolite data can determine or aid in determining the significance of genetic variants.

### SUMMARY

With the advent of the use of Whole Genome Sequencing (WGS) and Whole Exome Sequencing (WES) in the clinic for personalized medicine, to diagnose disease or determine the risk of disease, there is an unmet need for a comprehensive method of evaluating genetic sequence variants (subsequently referred to as “genetic variants” or simply as “variants”) for pathogenic (detrimental) affects and in so doing to determine the significance of the variant. The current methods are limited to evaluating the effects of variants in a single gene, are time and resource intensive, and lack comprehensive screening capabilities to detect a plethora of effects of the sequence variants on candidate genes. Therefore, there is a great demand for a better way to determine the sequence variants with potential negative or detrimental effects (i.e., “significant” genetic variants) and enable the classification of a variant with an unknown or uncertain clinical significance from VUS status to benign, pathogenic or advantageous. The methods described herein meet this need using a unique combination of metabolomics and computer technology.

Methods of using metabolomics to expedite personalized medicine based on genomic sequence analysis are described. Using metabolic profiles to determine (or aid in determining) the significance of genetic variants and enable the identification of diagnostic variants (those variants having a detrimental health affect) for use in personalized medicine is described. The metabolomic profiles contain data regarding both neutral (benign) and detrimental (pathogenic) effects of the variant. Further, using metabolic profiles to determine the presence of advantageous variants that may have a positive effect on patient health is also described.

In one embodiment, a method for identifying biochemical pathways affected by a genetic variant includes generating a small molecule profile from a subject with the variant, and comparing the small molecule profile to a reference small molecule profile from one or more individuals not having said variant; identifying biochemical components of the small molecule profile affected by the variant; and identifying biochemical pathways associated with said biochemical components, thus identifying biochemical pathways affected by the variant.

In another embodiment, a method of identifying diagnostic variants includes providing, in a computing device, a collection of data describing multiple biochemical pathways. Each biochemical pathway description identifies multiple compounds associated with said biochemical pathway. The method also includes obtaining a sample from one or more subjects with said variant and processing the sample using metabolomics analysis methods to acquire result data that indicates the effect of the variant on the metabolomic profile. The result data indicates a condition of at least one compound in the variant profile relative to a reference (control) profile. The method also identifies, using the collection of data describing the biochemical pathways, at least one biochemical pathway affected by the indicated variant. In an aspect related to this embodiment, a score is provided that allows ranking of variants.

In yet another embodiment, a method of identifying diagnostic variants includes the step of providing, in a computing device, a collection of data describing multiple biochemical pathways. Each biochemical pathway description identifies multiple compounds associated with the biochemical pathway. The method also includes analyzing a sample obtained from a subject with said variant and processing the sample using metabolomics analysis methods to acquire result data that indicates the effect of the variant on the metabolomic profile. The result data indicates a condition of at least one compound in the metabolomic profile relative to a reference (control) profile. The method also includes identifying programmatically without user assistance, using the collection of data describing the biochemical pathways, at least one biochemical pathway affected by the variant. In one aspect, a score is provided that allows ranking of variants.

In a further embodiment, a system for the determination of diagnostic variants includes a collection of data that describes multiple biochemical pathways. Each biochemical pathway description identifies multiple compounds associated with the biochemical pathway. The system also includes a data acquisition apparatus that processes the sample using metabolomics analysis methods to acquire result data that indicates the effect of the variant on the metabolomic profile. The processing of the sample using metabolomics analysis methods generates result data indicating a condition of at least one compound in the resulting metabolomic profile relative to a reference (control). The system additionally includes an analysis facility that executes on a computing device. The analysis facility is used with the collection of data describing the biochemical pathways to identify at least one biochemical pathway affected by the indicated condition of the at least one variant. In one aspect, the analysis facility provides a score that allows ranking of variants. In certain embodiments, no biochemical pathways may be affected by the variant. For example, when the target of the variant is not present in the sample type analyzed (e.g., a urine sample), it is possible that a variant may not affect any of the biochemical pathways in the metabolomic profile and no biochemical pathways will be identified. Further, in some instances, the variant does not affect the biochemical pathway in the metabolic profile (e.g., the variant is a neutral, benign or silent variant) and no biochemical pathway is identified.

Some embodiments described herein include systems, methods, and apparatuses for determining the significance of genetic variants using metabolomic profiling. Significance may be determined by classifying variants into categories and/or by ranking variants. Assignment of significance is based on biochemical components affected by the genetic variant and may also include other factors such as evolutionary conservation of the genetic variant, change in protein structure or function as a result of the genetic variant, or personal or family health history.

A significance score may be calculated for each variant. The system, method, and apparatus may compare the score(s) of a patient or population of patients to the score(s) of a standard small molecule profile.

The described methods may be used to determine the significance of a novel genetic variant or may be used to determine the significance of previously identified genetic variants. The genetic variants may also be ranked by order of significance or classified by significance. The data generated using the methods described herein may be used to re-classify a genetic variant(s) (e.g., from a variant of unknown significance (VUS) to a variant that is likely pathogenic or from a VUS to a variant that is likely not pathogenic or neutral). Such data may be useful to the physician or other health care provider by providing information that determines, or aids in determining, the diagnosis and/or treatment of the patient.

An embodiment includes a method for determining the significance of a genetic variant or plurality of variants. The method includes obtaining a sample from a subject having a genetic variant or plurality of variants and generating a small molecule profile of the sample including information regarding presence or absence of or a level of each of a plurality of small molecules in the sample. The method also includes comparing the small molecule profile of the sample to a reference small molecule profile that includes a standard range for a level of each of the plurality of small molecules and identifying a subset of the small molecules in the sample each having an aberrant level. An aberrant level of a small molecule in the sample is a level falling outside the standard range for the small molecule. The comparison and identification are conducted using an analysis facility executing on a processor of a computing device. The method further includes obtaining diagnostic information from a database based on the aberrant levels of the identified subset of the small molecules. The database holds information associating an aberrant level of one or more small molecules of the plurality of small molecules with information regarding a genetic variant for each of a plurality of genetic variants. The method also includes storing the obtained diagnostic information. The stored diagnostic information may include one or more of: an identification of at least one biochemical pathway associated with the identified subset of the small molecules having aberrant levels, an identification of at least one genetic variant associated with the identified subset of the small molecules having aberrant levels, and further, may include an identification of at least one recommended follow up test associated with the identified subset of the small molecules having aberrant levels.

### BRIEF DESCRIPTION OF THE DRAWINGS

The invention is pointed out with particularity in the appended claims. The advantages of the invention described above, as well as further advantages of the invention, may be better understood by reference to the following description taken in conjunction with the accompanying drawings, in which:

FIG. 1 depicts an environment suitable for practicing an embodiment of the present invention;

FIG. 2 depicts an alternative distributed environment suitable for practicing an embodiment of the present invention;

FIG. 3 is a flowchart of a sequence of steps that may be followed by an illustrative embodiment of the present invention to identify biochemical pathways affected by the genetic variant;

FIG. 4 is an exemplary concise visual display for the branched chain amino acid biochemical pathway that may be produced by an embodiment of the present invention to display metabolite data for certain biochemical pathways affected by the genetic variant.

### DETAILED DESCRIPTION

### Definitions

The language “small molecule profile” includes an inventory of small molecules (in tangible form or computer readable form) within a sample from a subject, or any derivative fraction thereof, that is necessary and/or sufficient to provide information to a user for its intended use within the methods described herein. The inventory would include the quantity and/or type of small molecules present. The information which is necessary and/or sufficient will vary depending on the intended use of the “small molecule profile.” For example, the “small molecule profile,” can be determined using a single technique for an intended use but may require the use of several different techniques for another intended use depending on such factors as the genetic variant involved, the disease state involved, the types of small molecules present in a particular sample, etc. In a further embodiment, the small molecule profile comprises information regarding at least 10, at least 25, at least 50, at least 100, at least 200, at least 300, at least 500, at least 1000, or at least 2000 small molecules. The terms “biochemical profile”, “metabolite profile”, “metabolomic profile” are used interchangeably with the term “small molecule profile”. In some instances the term “profile” may be used to refer to said inventory of small molecules.

The small molecule profiles can be obtained using HPLC (Kristal, et al. Anal. Biochem. 263:18-25 (1998)), thin layer chromatography (TLC), or electrochemical separation techniques (see, WO 99/27361, WO 92/13273, U.S. Pat. No. 5,290,420, U.S. Pat. No. 5,284,567, U.S. Pat. No. 5,104,639, U.S. Pat. No. 4,863,873, and U.S. RE32,920). Other techniques for determining the presence of small molecules or determining the identity of small molecules of the cell are also included, such as refractive index spectroscopy (RI), Ultra-Violet spectroscopy (UV), fluorescent analysis, radiochemical analysis, Near-InfraRed spectroscopy (Near-IR), Nuclear Magnetic Resonance spectroscopy (NMR), Light Scattering analysis (LS), gas-chromatography-mass spectroscopy (GC-MS), and liquid-chromatography-mass spectroscopy (LC-MS) and other methods known in the art, alone or in combination.

The term “effected” includes any modulation or other change caused by the variant. The term can include both increasing the activity and decreasing the activity of a biological pathway or portion thereof. It includes both up-regulation and down regulation and/or increased or decreased flux through the pathway and/or increased or decreased levels of metabolites in the pathway.

“Sample” or “biological sample” or “specimen” means biological material isolated from a subject. The biological sample may contain any biological material suitable for detecting the desired biomarkers, and may comprise cellular and/or non-cellular material from the subject. The sample can be isolated from any suitable biological fluid, tissue, or cells such as, for example, blood, blood plasma, serum, amniotic fluid, urine, cerebral spinal fluid, crevicular fluid, placenta, skin, epidermal tissue, adipose tissue, aortic tissue, liver tissue, or cell samples. The sample can be, for example, a dried blood spot where blood samples are blotted and dried on filter paper.

“Subject” means any animal, but is preferably a mammal, such as, for example, a human, monkey, non-human primate, rat, mouse, cow, dog, cat, pig, horse, or rabbit. Said subject may be symptomatic (i.e., having one or more characteristics that suggest the presence of or predisposition to a disease, condition or disorder, including a genetic indication of same) or may be asymptomatic (i.e., lacking said characteristics).

The “level” of one or more biomarkers means the absolute or relative amount or concentration of the biomarker in the sample.

“Small molecule”, “metabolite”, “biochemical” means organic and inorganic molecules which are present in a cell. The term does not include large macromolecules, such as large proteins (e.g., proteins with molecular weights over 2,000, 3,000, 4,000, 5,000, 6,000, 7,000, 8,000, 9,000, or 10,000), large nucleic acids (e.g., nucleic acids with molecular weights of over 2,000, 3,000, 4,000, 5,000, 6,000, 7,000, 8,000, 9,000, or 10,000), or large polysaccharides (e.g., polysaccharides with a molecular weights of over 2,000, 3,000, 4,000, 5,000, 6,000, 7,000, 8,000, 9,000, or 10,000). The small molecules of the cell are generally found free in solution in the cytoplasm or in other organelles, such as the mitochondria, where they form a pool of intermediates, which can be metabolized further or used to generate large molecules, called macromolecules. The term “small molecules” includes signaling molecules and intermediates in the chemical reactions that transform energy derived from food into usable forms. Non-limiting examples of small molecules include sugars, fatty acids, amino acids, nucleotides, intermediates formed during cellular processes, and other small molecules found within the cell.

“Aberrant” or “aberrant metabolite” or “aberrant level” refers to a metabolite or level of said metabolite that is either above or below a defined standard range. An aberrant metabolite may also include rare metabolites and/or missing metabolites. Any statistical method may be used to determine aberrant metabolites. By way of non-limiting example, for some metabolites, a log transformed level falling outside of at least 1.5*IQR (Inter Quartile Range) is aberrant. In another example, for some metabolites a log transformed level falling outside of at least 3.0*IQR is identified as aberrant. In some examples, data was analyzed assuming a log transformed level falling outside of at least 1.5*IQR is aberrant, and in some examples, data was analyzed assuming a log transformed level falling outside of at least 3.0*IQR is aberrant. In another example, for some metabolites, a metabolite having a log transformed level with a Z-score of >1 or <−1 is aberrant. In some embodiments, for some metabolites, a metabolite having a log transformed level with a Z-score of >1.5 or <−1.5 is aberrant. In some embodiments, for some metabolites, a metabolite having a log transformed level with a Z-score of >2.0 or <−2.0 is aberrant. In other embodiments, different ranges of Z-scores are used for different metabolites. In some embodiments, the defined standard range may be based on an IQR of a level, instead of an IQR of a log transformed level. In still other embodiments, the defined standard range may be based on a Z-score of a level, instead of on a Z-score of a log transformed level.

“Outlier” or “outlier value” refers to any biochemical that has a level either above or below the defined standard range. Any statistical method may be used to determine an outlier value. By way of non-limiting example the following tests may be used to identify outliers: t-tests, Z-scores, modified Z-scores, Grubbs' Test, Tietjen-Moore Test, Generalized Extreme Studentized Deviate (ESD), which can be performed on transformed data (e.g., log transformation) or untransformed data.

“Pathway” is a term commonly used to define a series of steps or reactions that are linked to one another. For example, a biochemical pathway whereby the product of one reaction is a substrate for a subsequent reaction. Biochemical reactions are not necessarily linear. Rather, the term biochemical pathway is understood to include networks of inter-related biochemical reactions involved in metabolism, including biosynthetic and catabolic reactions. “Pathway” without a modifier can refer to a “super-pathway” and/or to a “subpathway.” “Super-pathway” refers to broad categories of metabolism. “Subpathway” refers to any subset of a broader pathway. For example, glutamate metabolism is a subpathway of the amino acid metabolism biochemical super-pathway. An “abnormal pathway” means a pathway to which one or more aberrant biochemicals have been mapped, or that the biochemical distance for that pathway for the individual was high as compared with an expected biochemical distance for that pathway in a population (e.g., the biochemical distance for the pathway for the individual is among the highest 10%

The term “biochemical pathway” includes those pathways described in Roche Applied Sciences' “Metabolic Pathway Chart” or other pathways known to be involved in metabolism of organisms. Examples of biochemical pathways include, but are not limited to, carbohydrate metabolism (including, but not limited to, glycolysis, biosynthesis, gluconeogenesis, Kreb's Cycle, Citric Acid Cycle, TCA Cycle, pentose phosphate pathway, glycogen biosynthesis, galactose pathway, Calvin Cycle, amino sugars metabolism, butanoate metabolism, pyruvate metabolism, fructose metabolism, mannose metabolism, inositol phosphate metabolism, propanoate metabolism, starch and sucrose metabolism, etc.), energy metabolism (e.g., oxidative phosphorylation, reductive carboxylate cycle, etc.), lipid metabolism (including, but not limited to, triacylglycerol metabolism, activation of fatty acids, beta-oxidation of polyunsaturated fatty acids, beta-oxidation of other fatty acids, a-oxidation pathway, de novo biosynthesis of fatty acids, cholesterol biosynthesis, bile acid biosynthesis, fatty acid metabolism, glycerolipid metabolism, glycerophospholipid metabolism, sphingolipid metabolism, etc.) amino acid metabolism (including, but not limited to, glutamate reactions, Kreb-Henseleit urea cycle, shikimate pathway, phenylalanine and tyrosine biosynthesis, tryp-tophan biosynthesis, metabolism and/or degradation of particular amino acids (e.g., alanine, aspartate, arginine, proline, glutamate, glycine, serine, threonine, histadine, cysteine, methionine, phenylalanine, tryptophan, tyrosine, valine, leucine, or isoleucine metabolism and/or degradation, etc.), biosynthesis of amino acids (e.g., lysine and tryptophan biosynthesis, etc.), folate biosynthesis, one carbon pool by folate, pantothenate and CoA biosynthesis, riboflavin metabolism, thiamine metabolism, vitamin B6 metabolism, D-alanine metabolism, D-glutamine and D-glutamate metabolism, glutathionine metabolism, cyanoamino acid metabolism, N-glycan biosynthesis, benzoate degradation, alkaloid biosynthesis, selenoamino acid metabolism, purine metabolism, pyrimidine metabolism, phosphatidylinositol signaling system, neuroacive ligand-receptor interaction, energy metabolism (including, but not limited to, oxidative phosphorylation, ATP synthesis, photosynthesis, methane metabolism, etc.), phosphogluconate pathway, oxidation-reduction, electron transport, oxidative phosphorylation, respiratory metabolism (respiration), HMG-CoA reductase pathway, porphyrin synthesis pathway (heme synthesis), nitrogen metabolism (urea cycle), nucleotide biosynthesis, DNA replication, transcription, and translation. It also includes portions of these pathways and individual chemical reactions.

“Test sample” means the sample obtained from the individual subject to be analyzed.

“Reference sample” means a sample used for determining a standard range for a level of small molecules. “Reference sample” may refer to an individual sample from an individual reference subject (e.g., reference subject with only benign variants or reference subjects with deleterious variants or reference subject without a sequence variant in the gene or gene region under investigation), who may be selected to closely resemble the test subject by age, gender, ethnicity, and/or genetic condition. “Reference sample” may also refer to a sample including pooled aliquots from reference samples for individual reference subjects.

“Reference small molecule profile” or “Reference metabolomic profile” refers to the resulting profile generated using the “Reference sample”. Furthermore, the language “reference small molecule profile” includes information regarding the small molecules of the profile that is necessary and/or sufficient to provide information to a user for its intended use within the methods described herein. The reference profile would include the quantity and/or type of small molecules present. The ordinarily skilled artisan would know that the information which is necessary and/or sufficient will vary depending on the intended use of the “reference small molecule profile.” For example, the “reference small molecule profile,” can be determined using a single technique for an intended use but may require the use of several different techniques for another intended use depending on such factors as the types of small molecules present in a particular targeted sample type, cell, cellular compartment, the cellular compartment being assayed per se., etc. Examples of techniques that may be used have been described above and include, for example, GC-MS, LC-MS, LC-MS/MS, NMR, HPLC, uHPLC, etc and combinations thereof.

The term “identifying” includes both automated and non-automated methods of identifying biochemical components of the sample small molecule profile which are aberrant as compared to the reference small molecule profile. The term “aberrant” includes compounds which are present in greater or lesser amounts in the sample small molecule profile than the reference profile. In some instances, said greater or lesser amounts may be statistically significant.

The term “components” refers to those small molecules of the small molecule profile which are present in aberrant amounts compared to the standard small molecule profile.

After the biochemical components are identified, the identified biochemical components are analyzed using, for example, a database of biochemical pathways to pinpoint the particular pathways affected by a particular variant. Once the biochemical pathways are identified, biological effects of modulating these pathways are determined, including, for example, both detrimental and advantageous affects.

“Whole Genome Sequencing” or “WGS” is the process that determines the complete DNA sequence of an organism's genome at one time. The process includes sequencing of exons (protein-coding DNA) and introns (non-coding DNA).

“Whole Exome Sequencing” or “WES” is the process of determining the DNA sequence of all of the protein-coding genes (i.e., exons) in an organism.

“Targeted Sequencing” or “TS” is the process of determining the DNA sequence of an specific, isolated gene or genomic region of interest in an organism. Targeted sequencing refers to the sequencing of any specific subset of the genome or exome.

“Genetic Variant” or “Variant” refers to DNA sequence variations (e. g., polymorphisms or mutations). These genetic variations include single nucleotide polymorphisms (SNPs), as well as structural variants such as inserts/deletions (Indels), sequence rearrangements, copy number variants (CNVs), and transpositions. Differences in DNA sequences have many effects on an individual, including effects on health, susceptibility to diseases and disorders, and responses to pathogens and agents (including therapeutic agents, toxins, and toxicants). Variants may be classified as having a “positive” (advantageous) effect, a “negative” (detrimental, pathogenic, and/or deleterious) effect, a “neutral” (benign, not pathogenic, no clinical significance) effect or an “uncertain” (unknown, undetermined) effect.

“Variant of Unknown Significance” or “Variant of Uncertain Significance” or “VUS” refers to variants for which the clinical effect (if any) is unknown or uncertain.

Advanced metabolomic analyses is used to provide, at least in part, detailed information about a variant's effects on biochemical processes. Comparative evaluations between variants provide insight into each variant's quantitative and qualitative specificity. Results from concurrent analysis of variants with known detrimental effects can provide insight into predicting the clinical performance of the variants to diagnose or aid in diagnosis of disease or risk thereof and to facilitate treatment decisions and patient management.

Biochemical profiling analysis offering a unique opportunity to corroborate each variant's putative significance is described herein. Using the results, a determination of the most detrimental variants can be accomplished. The results are useful for determining the risk of a disease or disorder in the subject (or, in the event of a neutral variant, lack thereof).

In one embodiment, a method for identifying biochemical pathways affected by a genetic variant includes obtaining a small molecule profile of a sample from a subject with said variant, and comparing the small molecule profile to a reference WGS small molecule profile; identifying biochemical components of the small molecule profile affected by the variant; and identifying biochemical pathways associated with said components, thus identifying biochemical pathways affected by the variant. Further, it is possible to determine if the pathways are affected negatively (leading to disease or increase risk of disease) or positively (having a protective effect, decreasing susceptibility to disease).

The variants may be represented in existing data obtained through sequencing (e.g., Whole Genome Sequencing (WGS), Whole Exome Sequencing (WES), Targeted Sequencing (TS)) of the DNA of a patient. The patient may also provide additional data, including information about relevant diseases with which they have been diagnosed, and their age at diagnosis, and corresponding disease/age information for their family members (plus data that indicates the type of relation with each such family member (e.g., sibling, parent, grandparent, aunt/uncle, cousin, etc.). The patient's personal and family history may then be analyzed by computer for a list of diseases of relevant concern.

Automated and/or semi-automated methods, computer programs, and other related mediums for performing the described methods are explained herein.

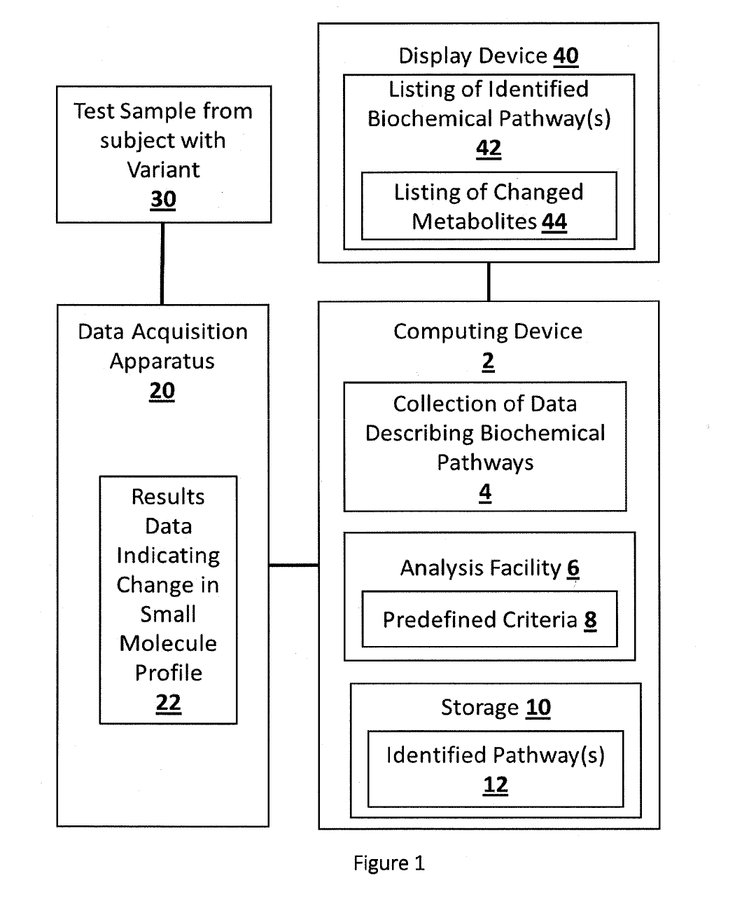

FIG. 1 depicts an environment suitable for practicing an embodiment of the present invention. A computing device 2 holds or enables access to a collection of data describing biochemical pathways 4. The computing device 2 may be a server, workstation, laptop, personal computer, PDA or other computing device equipped with one or more processors and able to execute the analysis facility 6 discussed herein. The collection of data describing biochemical pathways 4 may be stored in a database. The collection of data describing biochemical pathways 4 describes multiple biochemical pathways with each biochemical pathway description identifying multiple compounds associated with a particular biochemical pathway. The analysis facility 6 is preferably implemented in software although in an alternate implementation, the logic may be also be implemented in hardware. The analysis facility 6 operates on and analyzes results data 22 received from a data acquisition apparatus 20. As will be explained further below, the results data 22 indicates a condition of a compound in a small molecule profile 30 that is being processed by the data acquisition apparatus 20 from a sample obtained from an individual with a variant.

The data acquisition apparatus 20 processes a sample from one or more subjects with a variant in order to determine the effect or non-effect of the variant on the small molecule profile. Suitably, the data acquisition apparatus 20 may include gas chromatography-mass spectrometry (GC-MS), liquid chromatography, gas chromatography, mass spectrometry, liquid chromatography-mass spectrometry (LC-MS) or other techniques able to analyze the effect of the variant on the small molecule profile, as described above. The processing of the sample having the variant 30 by the data acquisition apparatus 20 generates results data 22 that indicates a condition of at least one compound (e.g., a small molecule profile) in the test sample relative to a control (e.g., standard small molecule profile). The indicated condition may reflect a change in the compound (and associated biochemical pathway(s)) as a result of the presence of the variant 30. Alternatively, the indicated condition of the compound may reflect that the compound has not changed as a result of the presence of the variant 30 in the sample analyzed. It will be appreciated that the lack of a change in the compound may represent an expected and/or desired result depending upon the identity of the variant and the type of sample analyzed. The results data 22 is provided to the analysis facility 6 executing on the computing device 2. As will be appreciated, there are a number of ways in which the results data may be transmitted to the computing device 2 including, but not limited to, the use of a direct or networked connection between the data acquisition apparatus 20 and the computing device 2 or by saving the results data to a storage medium such as a compact disc that is then transferred to the computing device 2. For ease of illustration, FIG. 1 depicts a direct connection between the data acquisition apparatus 20 and the computing device 2 over which the results data 22 may be conveyed. Those skilled in the art will recognize that many other configurations are also possible within the scope of the present invention.

The analysis facility 6 uses the results data indicating a condition of one or more compounds 22 together with the collection of data describing biochemical pathways 4 to identify one or more biochemical pathways affected by the presence of the variant 30. A beneficial aspect of this technique is that it enables the effect of a variant to be studied on a broad range of biochemical pathways rather than just a narrowly targeted study as is done with conventional techniques. This allows both expected and unexpected effects of a variant to be identified much faster and earlier in the evaluation process. As will be appreciated, the determination of the affects (negative effects or positive effects) of a variant in the genomic analysis process can result in substantial monetary and time savings to the patient and the physician attempting to understand and interpret the effects of genetic variants on health.

In one implementation, the comparison of the results data 22 to the collection of data describing biochemical pathways 4 in order to identify the affected biochemical pathways is performed programmatically without any user input. In alternate implementations, the analysis facility 6 prompts a user for parameters for the comparison. The parameters may limit for example, the number of compounds indicated in the results data 22 that are to be compared with the collection of data describing biochemical pathways 4. Alternatively, the parameters solicited from a user by the analysis facility 6 may limit the amount of the collection of data describing biochemical pathways 4 that is searched. Additional types of user input and parameters that may be solicited from the user by the analysis facility 6 will occur to those skilled in the art and are considered to be within the scope of the present invention.

As noted above, the analysis facility 6 uses the results data indicating a condition of one or more compounds 22 together with the collection of data describing biochemical pathways 4 to identify one or more biochemical pathways affected by the presence of the variant 30. A listing of the identified biochemical pathways 42 may be transmitted to, and displayed on, a display device 40 in communication with the computing device 2. As will be discussed further below, the listing of the identified biochemical pathways 42 may also list details of changes in metabolites 42 in the identified biochemical pathways 40. Alternatively, a listing of the identified biochemical pathways 12 may be stored in storage 10 for later analysis or presentment to a user. For ease of illustration, storage 10 is depicted as being located on the computing device 2 in FIG. 1. It will be appreciated that storage 10 could also be located at other locations accessible to computing device 2.

The analysis facility 6 may also include, or have access to, pre-defined criteria 8 which is used to interpret the meaning of the identified condition of the affected biochemical pathways. In one implementation, the pre-defined criteria may be used to programmatically provide an interpretation without user input. In other implementations, varying degrees of user input in addition to a programmatic application of the pre-defined criteria may be used to interpret the meaning of an identified change in biochemical pathways. In still other implementations, the interpretation may be wholly provided by a user presented with a listing of the identified biochemical pathways by the analysis facility 6. As discussed further in reference to the Concise Report presented in Table 4 below, the interpretation may provide information on the significance of identified metabolite or small molecule changes in the biochemical pathways. The pre-defined criteria may be held in a database accessible to the analysis facility 6.

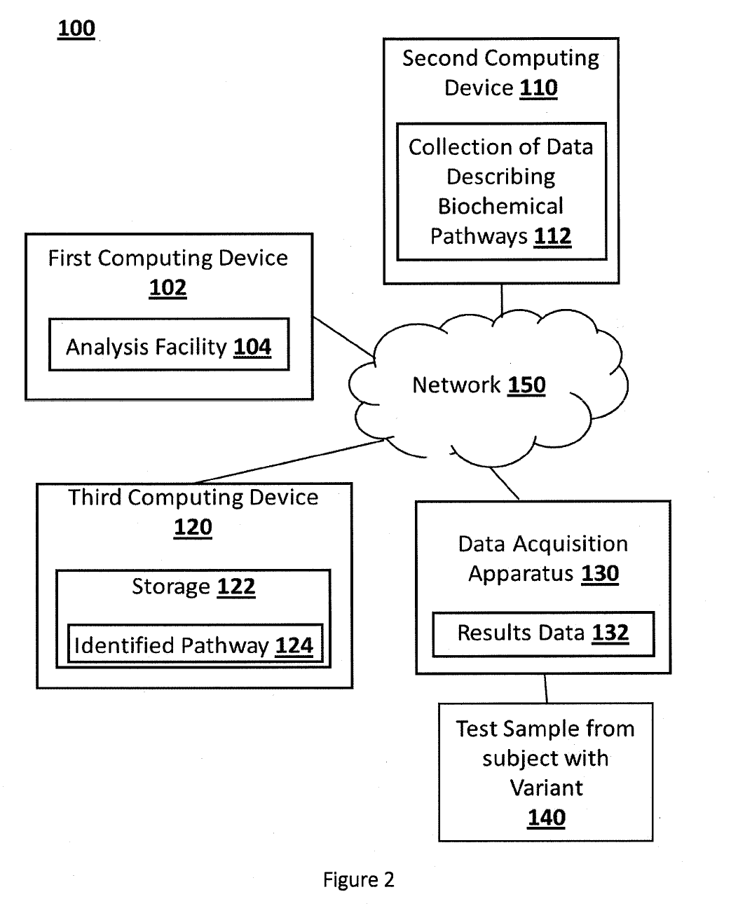

FIG. 2 depicts an alternative distributed environment suitable for practicing an embodiment of the present invention. A first computing device 102 may be used to execute an analysis facility 104. The first computing device may communicate over a network 150 with a second computing device 110 holding a collection of data describing biochemical pathways 112. The network 150 may be the Internet, a local area network (LAN), a wide area network (WAN), an intranet, an internet, a wireless network or some other type of network over which the first computing device 102 and the second computing device 110 can communicate. The analysis facility 104 on the first computing device 102 may communicate over the network 150 with a data acquisition apparatus 130 generating results data 132 from the processing of a sample from a subject with a variant 140. The analysis facility 104 may store a listing of identified biochemical pathways 124 affected by the presence of the variant in the subject from whom the sample was obtained that is obtained by processing the results data 132 and the collection of data describing biochemical pathways 112 in storage 122. Storage 122 may be located on a third computing device 120 accessible over the network 150. It should be recognized that FIG. 2 depicts only a single distributed configuration and many other distributed configurations are possible within the scope of the present invention.

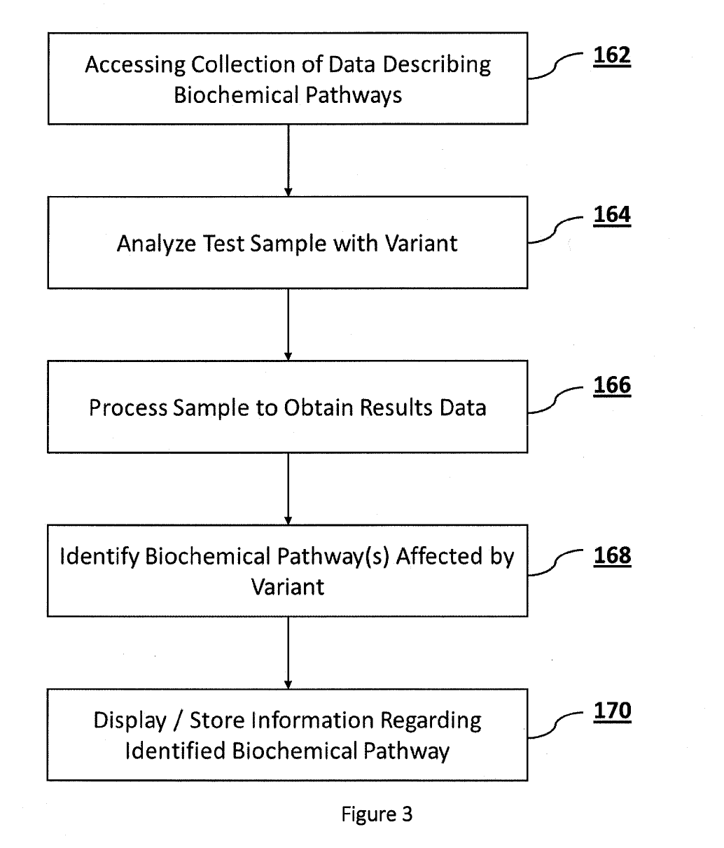

FIG. 3 is a flowchart of a sequence of steps that may be followed by an embodiment of the present invention to identify biochemical pathways affected by alternate variant forms (i.e. different variants within the same gene, such as a different SNP, insertion, deletion, etc.; also referred to as alleles). The sequence begins by accessing a collection of data describing biochemical pathways (step 162). A sample from a subject with a certain variant is analyzed to produce a metabolomic profile (step 164) and the data is processed by a data acquisition apparatus to obtain results data (step 166) as discussed above. The results data and the collection of data describing biochemical pathways is then used by the analysis facility to identify biochemical pathways affected by the presence of the variant in the subject from whom the sample was collected (step 168). A map or listing of the affected biochemical pathways may then be displayed to a user or stored for later retrieval (step 170).

One beneficial aspect of the present invention is the ability of the analysis facility to generate a visual display indicating the effects associated with the variant being studied. For example, the analysis facility can produce a visual display of a network of biochemical pathways (biochemical network) displaying metabolite data for the biochemical pathways and enabling an analyst to identify biochemicals and biochemical pathways affected by the presence of the variant. In an exemplary display, rectangles may represent enzymes, circles may represent metabolites, arrows may represent reactions in the biochemical pathway, and filled circles may represent metabolites detected in a patient sample. Further, the size of the circle may represent a change, if any, in the level of the biochemical, with the magnitude of change (increase or decrease) of the biochemical relative to the reference level indicated by the size of the circle. For example, the larger the circle, the larger the difference between the measured metabolite level and the reference level. In addition, the color of the filled circle may indicate the direction of change (increase or decrease) of the biochemical relative to the reference level. For example, a red circle may indicate an increase in the measured level of the biochemical while a green circle may indicate a decrease in the measured level of the biochemical.

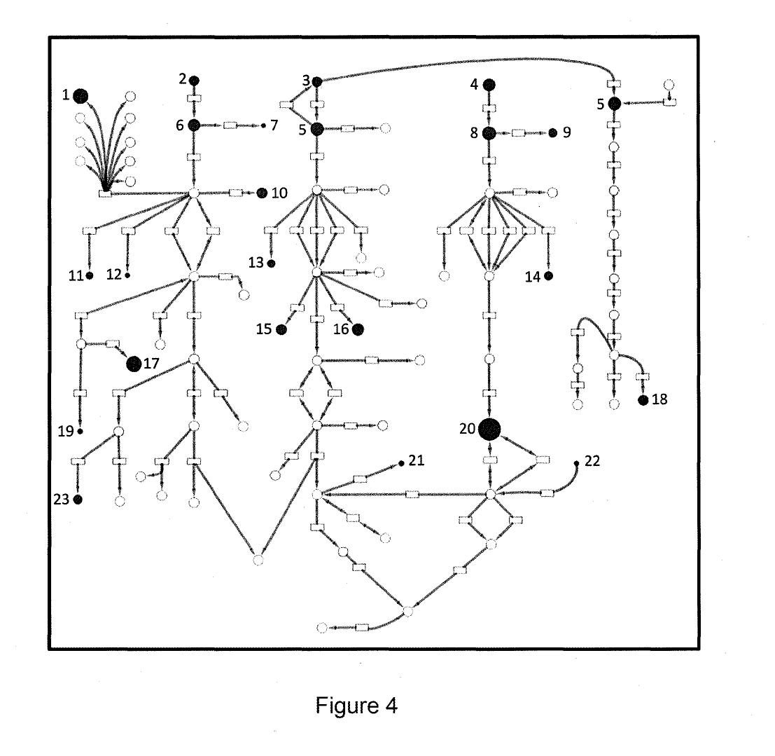

FIG. 4 provides an exemplary concise visual display highlighting a portion of a biochemical pathway network that is affected by a variant under investigation. The concise display also includes a listing (not shown) of the biochemicals affected by the presence of the variant in the individual on the sample analyzed. In one implementation, a visual indicator may be provided for a user to indicate the type of metabolite change. For example, one color may be used to indicate an increase in a metabolite level for a particular biochemical pathway while a second color may be used to indicate a decrease in a metabolite level for the particular biochemical pathway. Similarly, other types of visual indicators may be used in place of, or in addition to color, to convey information to a user. The use of a visual indicator is an additional benefit of the present invention in that it facilitates quick recognition of an overall effect for a variant. For example, if the color red is being used to indicate an increase in metabolite (or small molecule) levels in biochemical pathways and a variant causes widespread increases in metabolite levels, a user glancing quickly at the concise report will be able to quickly ascertain the effect of the variant. For cases where there are many biochemical pathways affected by the variant being studied the visual indicator thus provides an efficient mechanism for conveying information.

In the concise display exemplified in FIG. 4, rectangles are used to represent enzymes, and circles are used to represent metabolites; arrows are used to represent reactions in the biochemical pathway; filled circles are used to represent metabolites detected in this patient sample. The size of the circle is used to represent the magnitude of the change of the metabolite relative to the reference level (i.e., the larger the circle, the larger the measured difference in metabolite level compared to the reference level). Numbers are used to indicate the metabolites measured in the patient sample: (1) 3-hydroxyisovalerate; (2) leucine; (3) isoleucine; (4) valine; (5) 3-methyl-2-oxovalerate; (6) 4-methyl-2-oxovalerate; (7) alpha-hydroxyisocaproate; (8) 3-methyl-2-oxobutyrate; (9) alpha-hydroxyisovalerate; (10) isovalerate; (11) isovalerylcarnitine; (12) isovalerylglycine; (13) 2-methylbutyrylcarnitine (C5); (14) isobutyrylcarnitine; (15) tigloylglycine; (16) tiglyl carnitine; (17) 3-hydroxyisovalerate; (18) butyrylcarnitine; (19) hydroxyisovaleroyl carnitine; (20) 3-hydroxyisobutyrate; (21) Propionylcarnitine; (22) 3-aminoisobutyrate; (23) 3-methylglutarylcarnitine (C6).

One beneficial aspect of the present invention is the ability of the analysis facility to generate a concise report indicating the effects associated with the variant being studied. Presented in Table 4 below is an exemplary concise report that may be produced by the analysis facility to display metabolite data for biochemical pathways identified as affected by the presence of the variant. The concise report includes a title indicating a variant being studied. The concise report also includes a listing of the biochemical pathways affected by the presence of the variant in the individual on the sample analyzed. Additional columns corresponding to alternate variant forms may also be provided. For example, a column including results for a detrimental variant versus a control and a benign variant versus a control may be provided. The results data in the columns may list any metabolite changes within the affected biochemical pathways.

The concise report may also include a footnote column referencing portions of an interpretation discussing the meaning of the identified changes in metabolite levels in the various biochemical pathways. The interpretation may be generated programmatically by the analysis facility, may be supplied manually by a user looking at the rest of the concise report, or may be a hybrid that is produced in part by the analysis facility and in part by a user.

One or more computer-readable programs embodied on or in one or more mediums may implement the described methods. The mediums may be a floppy disk, a hard disk, a compact disc, a digital versatile disc, a flash memory card, a PROM, a RAM, a ROM, or a magnetic tape. In general, the computer-readable programs may be implemented in any programming language. Some examples of languages that can be used include FORTRAN, C, C++, C#, or JAVA. The software programs may be stored on or in one or more mediums as object code. Hardware acceleration may be used and all or a portion of the code may run on a FPGA or an ASIC. The code may run in a virtualized environment such as in a virtual machine. Multiple virtual machines running the code may be resident on a single processor. The code may be run using more than one processor having two or more cores each.

Since certain changes may be made without departing from the scope of the present invention, it is intended that all matter contained in the above description or shown in the accompanying drawings be interpreted as illustrative and not in a literal sense. Practitioners of the art will realize that the sequence of steps and architectures depicted in the figures may be altered without departing from the scope of the present invention and that the illustrations contained herein are singular examples of a multitude of possible depictions of the present invention.

### EXAMPLES

### I. General Methods.

### A. Metabolomic Profiling.

The metabolomic platforms consisted of three independent methods: ultrahigh performance liquid chromatography/tandem mass spectrometry (UHLC/MS/MS²) optimized for basic species, UHLC/MS/MS² optimized for acidic species, and gas chromatography/mass spectrometry (GC/MS).

### B. Sample Preparation.

Samples were stored at −80° C. until needed and then thawed on ice just prior to extraction. Extraction was executed using an automated liquid handling robot (MicroLab Star, Hamilton Robotics, Reno, Nev.), where 450 μl methanol was added to 100 μl of each sample to precipitate proteins. The methanol contained four recovery standards to allow confirmation of extraction efficiency. Each solution was then mixed on a Geno/Grinder 2000 (Glen Mills Inc., Clifton, N.J.) at 675 strokes per minute and then centrifuged for 5 minutes at 2000 rpm. Four 110 μl aliquots of the supernatant of each sample were taken and dried under nitrogen and then under vacuum overnight. The following day, one aliquot was reconstituted in 50 μL of 6.5 mM ammonium bicarbonate in water at (pH 8) and one aliquot was reconstituted using 50 μL 0.1% formic acid in water. Both reconstitution solvents contained sets of instrument internal standards for marking an LC retention index and evaluating LC-MS instrument performance. A third 110 μl aliquot was derivatized by treatment with 50 μL of a mixture of N,O-bis trimethylsilyltrifluoroacetamide and 1% trimethylchlorosilane in cyclohexane: dichloromethane: acetonitrile (5:4:1) plus 5% triethylamine, with internal standards added for marking a GC retention index and for assessment of the recovery from the derivatization process. This mixture was then dried overnight under vacuum and the dried extracts were then capped, shaken for five minutes and then heated at 60° C. for one hour. The samples were allowed to cool and spun briefly to pellet any residue prior to being analyzed by GC-MS. The remaining aliquot was sealed after drying and stored at −80° C. to be used as backup samples, if necessary. The extracts were analyzed on three separate mass spectrometers: one UPLC-MS system employing ultra-performance liquid chromatography-mass spectrometry for detecting positive ions, one UPLC-MS system detecting negative ions, and one Trace GC Ultra Gas Chromatograph-DSQ gas chromatography-mass spectrometry (GC-MS) system (Thermo Scientific, Waltham, Mass.).

### C. UPLC Method.

All reconstituted aliquots analyzed by LC-MS were separated using a Waters Acquity UPLC (Waters Corp., Milford, MA). The aliquots reconstituted in 0.1% formic acid used mobile phase solvents consisting of 0.1% formic acid in water (A) and 0.1% formic acid in methanol (B). Aliquots reconstituted in 6.5 mM ammonium bicarbonate used mobile phase solvents consisting of 6.5 mM ammonium bicarbonate in water, pH 8 (A) and 6.5 mM ammonium bicarbonate in 95/5 methanol/water. The gradient profile utilized for both the formic acid reconstituted extracts and the ammonium bicarbonate reconstituted extracts was from 0.5% B to 70% B in 4 minutes, from 70% B to 98% B in 0.5 minutes, and hold at 98% B for 0.9 minutes before returning to 0.5% B in 0.2 minutes. The flow rate was 350 μL/min. The sample injection volume was 5 μL and 2× needle loop overfill was used. Liquid chromatography separations were made at 40° C. on separate acid or base-dedicated 2.1 mm×100 mm Waters BEH C18 1.7 μm particle size columns.

### D. UPLC-MS Methods.

An OrbitrapElite (OrbiElite Thermo Scientific, Waltham, Mass.) mass spectrometer was used for some examples. The OrbiElite mass spectrometer utilized a HESI-II source with sheath gas set to 80, auxiliary gas at 12, and voltage set to 4.2 kV for positive mode. Settings for negative mode had sheath gas at 75, auxiliary gas at 15 and voltage was set to 2.75 kV. The source heater temperature for both modes was 430° C. and the capillary temperature was 350° C. The mass range was 99-1000 m/z with a scan speed of 4.6 total scans per second also alternating one full scan and one MS/MS scan and the resolution was set to 30,000. The Fourier Transform Mass Spectroscopy (FTMS) full scan automatic gain control (AGC) target was set to 5×10⁵ with a cutoff time of 500 ms. The AGC target for the ion trap MS/MS was 3×10³ with a maximum fill time of 100 ms. Normalized collision energy for positive mode was set to 32 arbitrary units and negative mode was set to 30. For both methods activation Q was 0.35 and activation time was 30 ms, again with a 3 m/z isolation mass window. The dynamic exclusion setting with 3.5 second duration was enabled for the OrbiElite. Calibration was performed weekly using an infusion of Pierce™ LTQ Velos Electrospray Ionization (ESI) Positive Ion Calibration Solution or Pierce™ ESI Negative Ion Calibration Solution.

For some examples, LC/MS analysis used a Waters ACQUITY ultra-performance liquid chromatography (UPLC) and a Thermo Scientific Q-Exactive high resolution/accurate mass spectrometer interfaced with a heated electrospray ionization (HESI-II) source and Orbitrap mass analyzer operated at 35,000 mass resolution. The sample extract was dried then reconstituted in acidic or basic LC-compatible solvents, each of which contained 8 or more injection standards at fixed concentrations to ensure injection and chromatographic consistency. One aliquot was analyzed using acidic positive ion optimized conditions and the other using basic negative ion optimized conditions in two independent injections using separate dedicated columns (Waters UPLC BEH C18-2.1×100 mm, 1.7 μm). Extracts reconstituted in acidic conditions were gradient eluted from a C18 column using water and methanol containing 0.1% formic acid. The basic extracts were similarly eluted from C18 using methanol and water containing with 6.5 mM Ammonium Bicarbonate. The third aliquot was analyzed via negative ionization following elution from a HILIC column (Waters UPLC BEH Amide 2.1×150 mm, 1.7 μm) using a gradient consisting of water and acetonitrile with 10mM Ammonium Formate. The MS analysis alternated between MS and data-dependent MS2 scans using dynamic exclusion, and the scan range was from 80-1000 m/z.

### E. GC-MS Method.

Derivatized samples were analyzed by GC-MS. A sample volume of 1.0 μl was injected in split mode with a 20:1 split ratio on to a diphenyl dimethyl polysiloxane stationary phase, thin film fused silica column, Crossbond RTX-5Sil, 0.18 mm i.d.×20 m with a film thickness of 20 μm (Restek, Bellefonte, Pa.). The compounds were eluted with helium as the carrier gas and a temperature gradient that consisted of the initial temperature held at 60° C. for 1 minute; then increased to 220° C. at a rate of 17.1° C./minute; followed by an increase to 340° C. at a rate of 30° C./minute and then held at this temperature for 3.67 minutes. The temperature was then allowed to decrease and stabilize to 60° C. for a subsequent injection. The mass spectrometer was operated using electron impact ionization with a scan range of 50-750 mass units at 4 scans per second, 3077 amu/sec. The dual stage quadrupole (DSQ) was set with an ion source temperature of 290° C. and a multiplier voltage of 1865 V. The MS transfer line was held at 300° C. Tuning and calibration of the DSQ was performed daily to ensure optimal performance.

### F. Data Processing and Analysis.

For each biological matrix data set on each instrument, relative standard deviations (RSDs) of peak area were calculated for each internal standard to confirm extraction efficiency, instrument performance, column integrity, chromatography, and mass calibration. Several of these internal standards serve as retention index (RI) markers and were checked for retention time and alignment. Modified versions of the software accompanying the UPLC-MS and GC-MS systems were used for peak detection and integration. The output from this processing generated a list of m/z ratios, retention times and area under the curve values. Software specified criteria for peak detection including thresholds for signal to noise ratio, height and width.

The biological data sets, including QC samples, were chromatographically aligned based on a retention index that utilizes internal standards assigned a fixed RI value. The RI of the experimental peak is determined by assuming a linear fit between flanking RI markers whose values do not change. The benefit of the RI is that it corrects for retention time drifts that are caused by systematic errors such as sample pH and column age. Each compound's RI was designated based on the elution relationship with its two lateral retention markers. Using an in-house software package, integrated, aligned peaks were matched against an in-house library (a chemical library) of authentic standards and routinely detected unknown compounds, which is specific to the positive, negative or GC-MS data collection method employed. Matches were based on retention index values within 150 RI units of the prospective identification and experimental precursor mass match to the library authentic standard within 0.4 m/z for the LTQ and DSQ data. The experimental MS/MS was compared to the library spectra for the authentic standard and assigned forward and reverse scores. A perfect forward score would indicate that all ions in the experimental spectra were found in the library for the authentic standard at the correct ratios and a perfect reverse score would indicate that all authentic standard library ions were present in the experimental spectra and at correct ratios. The forward and reverse scores were compared and a MS/MS fragmentation spectral score was given for the proposed match. All matches were then manually reviewed by an analyst that approved or rejected each call based on the criteria above. However, manual review by an analyst is not required. In some embodiments the matching process is completely automated.

Further details regarding a chemical library, a method for matching integrated aligned peaks for identification of named compounds and routinely detected unknown compounds, and computer-readable code for identifying small molecules in a sample may be found in U.S. Pat. No. 7,561,975, which is incorporated by reference herein in its entirety.

### G. Quality Control.

From the biological samples, aliquots of each of the individual samples were combined to make technical replicates, which were extracted as described above. Extracts of this pooled sample were injected six times for each data set on each instrument to assess process variability. As an additional quality control, five water aliquots were also extracted as part of the sample set on each instrument to serve as process blanks for artifact identification. All QC samples included the instrument internal standards to assess extraction efficiency, and instrument performance and to serve as retention index markers for ion identification. The standards were isotopically labeled or otherwise exogenous molecules chosen so as not to obstruct detection of intrinsic ions.

### H. Statistical Analysis.

One approach for statistical analysis was to identify “extreme” values (outliers) in each of the metabolites detected in the sample. A two-step process was performed based on the percent fill (the percentage of samples for which a value was detected in the metabolites). When the fill was less than or equal 10%, samples in which a value is detected were flagged. When the fill was greater than 10%, the missing values were imputed with a random normal variable with mean equal to the observed minimum and standard deviation equal to 1. The data was then Log transformed, and the Inter Quartile Range (IQR), defined as the difference between the 3^{rd} and 1^{st} quartiles, was calculated. Values that were greater than 1.5*IQR above the 3^{rd} quartile or 1.5*IQR below the 1^{st} quartile were then flagged. The log transformed data were also analyzed to calculate the Z-score for each metabolite in each individual. The Z-score of the metabolite for an individual represents the number of standard deviations above the mean for the given metabolite. A positive Z-score means the metabolite level is above the mean and a negative Z-score means the metabolite level is below the mean.

In metabolomics, there is interest not only in changes for individual metabolites, but also for groups of related metabolites (e.g., biochemical pathways). The analysis of related metabolites could be particularly useful in instances where the individual metabolites miss the cut-off for statistical significance using univariate analyses, but in aggregate are found to be statistically significant. For example, suppose there are eight metabolites with p-values of 0.07 in a pathway. If the pair-wise correlations are 0.99, then the aggregate p-value is expected to be similar to an individual p-value. However, if the metabolites are uncorrelated, then the Fisher meta-analysis [1] p-value=0.0003. So the aggregate p-value could range from 0.07 (all correlated=1) to 0.0003. Hence, it is desirable to formally test whether a pathway is changed.

For genomics pathway analysis, the methods of data analysis often involve combining the p-values of individual members of a pathway for an aggregate p-value analysis (e.g., Fisher's method, Tail Strength, Adaptive Rank Truncated Product). Multivariate methods (e.g., Hotellings T², Dempster's Test, Bai-Saranadasa Test, Srivastava-Du Test), with the exception of PCA, are often not considered. Some of these methods, such as Hotelling's T² statistic, require the inversion of the sample covariance matrix, which is not possible when the number of observations is less than the number of variables, as is typically the case for -omics data. Furthermore, some of these results rely on asymptotic results, which require even larger sample sizes. Thus, in genomics, many of these statistics will not apply. However, metabolomics datasets often have fewer than 1,000 variables, and many of the biochemical pathways contain fewer than 20 metabolites. Thus, these multivariate statistics can apply in many cases for metabolomics data.

We applied these methods to a human metabolomics data set concerning insulin resistance. Insulin resistant subjects, “IR”, (n₁=261) were compared to insulin sensitive subjects, “IS”, (n₂=138). This data set represents many of the challenges in performing pathway analysis (e.g., many metabolites occur in multiple pathways and some pathways have a higher percentage of detected metabolites than others). For this example, each metabolite was assigned to a single pathway as defined by in-house experts, who made use of such public databases as KEGG. Pathways with only one representative metabolite were excluded from the analysis. Since this data set had large sample sizes, the permutation distributions for each statistic were determined from 10,000 permutations.

Table 1 shows a summary of the results from performing Welch's two-sample t-test for each metabolite. After dropping pathways where only one metabolite was observed, 39 pathways remained. Column 1 of Table 1 shows the pathway number, Column 2 is the biochemical pathway, Column 3 is the number of metabolites detected in the study within in the biochemical pathway, Column 4 is the number of metabolites significantly altered for the comparison, and Columns 5 & 6 represent the range of p-values for the biochemical pathway metabolites. There was one pathway where every member was significant at the 0.05 level (P02=benzoate metabolism). However, using statistical methods to analyze the significance of the biochemical pathway, more than half of the pathways were significant at the 0.05-level (before correcting for multiple comparisons) as shown in Table 2. In Table 2, FX=Fisher's statistic using the chi-squared distribution; FP=Fisher's statistic using the permutation distribution; TS=tail strength statistic; ARTP=adaptive rank truncated product; PCA, the results from performing the two-sample t-test on the first principal component; HT=Hotellings' T²; BSN=Bai-Saranadasa statistic using the normal approximation; BSP=Bai-Saranadasa statistic using the permutation distribution; DM=Demspster's statistics; and SD=Srivastava and Du's statistic. There are several pathways that are statistically significant where fewer than half the individual biochemicals reached the 0.05 level. One example is P37 (tryptophan metabolism) where only one of its eight metabolites had a p-value less than 0.05, but the pathway itself was significantly altered using all statistical tests with the exception of Tail Strength. One of the main reasons for this is that the pairwise correlations are very low—the vast majority of the pairwise correlations are below 0.3. Overall, for this example, p-value aggregation methods and the multivariate statistics give similar results.

TABLE 1
Results summary: Individual metabolite significance, Welch's two
sample t-test

| Number | Biochemical Pathway | m | sig | Max p | Min p |
|---|---|---|---|---|---|
| P01 | Alanine and Aspartate Metabolism | 4 | 0 | 0.6721 | 0.4519 |
| P02 | Benzoate Metabolism | 3 | 3 | 0.0386 | 2.41E−06 |
| P03 | Carnitine Metabolism | 2 | 0 | 0.4179 | 0.2534 |
| P04 | Creatine Metabolism | 2 | 1 | 0.0713 | 2.95E−06 |
| P05 | Fatty Acid Metabolism (also BCAA | 2 | 1 | 0.363 | 0.0002 |
| | Metabolism) | | | | |
| P06 | Fatty Acid Metabolism(Acyl Carnitine) | 8 | 4 | 0.6591 | 3.81E−05 |
| P07 | Fatty Acid, Dicarboxylate | 2 | 0 | 0.7851 | 0.5707 |
| P08 | Fatty Acid, Monohydroxy | 2 | 0 | 0.1444 | 0.0633 |
| P09 | Food Compound/Plant | 6 | 1 | 0.9781 | 0.0032 |
| P10 | Fructose, Mannose and Galactose Metabolism | 3 | 1 | 0.8279 | 4.25E−07 |
| P11 | Gamma-glutamyl Amino Acid | 7 | 3 | 0.3994 | 0.0272 |
| P12 | Glutamate Metabolism | 3 | 0 | 0.753 | 0.1326 |
| P13 | Glycerolipid Metabolism | 2 | 0 | 0.1334 | 0.054 |
| P14 | Glycine, Serine and Threonine Metabolism | 5 | 4 | 0.999 | 1.60E−07 |
| P15 | Glycolysis, Gluconeogenesis, and Pyruvate | 5 | 2 | 0.4057 | 9.70E−05 |
| | Metabolism | | | | |
| P16 | Hemoglobin and Porphyrin Metabolism | 5 | 1 | 0.4169 | 0.008 |
| P17 | Leucine, Isoleucine and Valine Metabolism | 13 | 8 | 0.6672 | 3.22E−05 |
| P18 | Long Chain Fatty Acid | 11 | 4 | 0.7849 | 6.70E−06 |
| P19 | Lysine Metabolism | 4 | 0 | 0.8485 | 0.2271 |
| P20 | Lysolipid | 24 | 14 | 0.7215 | 2.08E−05 |
| P21 | Medium Chain Fatty Acid | 7 | 2 | 0.9093 | 0.0051 |
| P22 | Methionine, Cysteine, SAM and Taurine | 5 | 3 | 0.9603 | 1.73E−19 |
| | Metabolism | | | | |
| P23 | Monoacylglycerol | 2 | 1 | 0.2578 | 0.0323 |
| P24 | Nicotinate and Nicotinamide Metabolism | 2 | 1 | 0.5845 | 1.50E−06 |
| P25 | Phenylalanine and Tyrosine Metabolism | 8 | 3 | 0.9331 | 1.24E−05 |
| P26 | Phospholipid Metabolism | 2 | 1 | 0.311 | 0.0019 |
| P27 | Polypeptide | 3 | 2 | 0.3674 | 0.0003 |
| P28 | Polyunsaturated Fatty Acid (n3 and n6) | 10 | 5 | 0.8412 | 5.15E−06 |
| P29 | Primary Bile Acid Metabolism | 3 | 0 | 0.7889 | 0.5531 |
| P30 | Purine Metabolism, (Hypo)Xanthine/Inosine | 3 | 1 | 0.4557 | 2.15E−06 |
| | containing | | | | |
| P31 | Purine Metabolism, Adenine containing | 2 | 0 | 0.1332 | 0.0563 |
| P32 | Pyrimidine Metabolism, Uracil containing | 2 | 0 | 0.7619 | 0.2288 |
| P33 | Secondary Bile Acid Metabolism | 6 | 0 | 0.9291 | 0.0614 |
| P34 | Steroid | 14 | 5 | 0.7938 | 0.0042 |
| P35 | Sterol | 3 | 0 | 0.8001 | 0.132 |
| P36 | TCA Cycle | 4 | 3 | 0.1851 | 0.0201 |
| P37 | Tryptophan Metabolism | 8 | 1 | 0.943 | 5.74E−05 |
| P38 | Urea cycle; Arginine and Proline Metabolism | 9 | 2 | 0.8732 | 0.0082 |
| P39 | Xanthine Metabolism | 4 | 1 | 0.8879 | 0.014 |

TABLE 2
Results summary: Biochemical pathway significance

| Number | Pathway | m | FP | TS | ARTP | PCA | HT | BSP | DM | SD |
|---|---|---|---|---|---|---|---|---|---|---|
| P01 | Alanine and | 4 | 0.792 | 0.828 | 0.873 | 0.656 | 0.834 | 0.783 | 0.783 | 0.855 |
| | Aspartate | | | | | | | | | |
| | Metabolism | | | | | | | | | |
| P02 | Benzoate | 3 | <0.0001 | 0.001 | <0.0001 | 0.000 | 0.000 | <0.0001 | <0.0001 | <0.0001 |
| | Metabolism | | | | | | | | | |
| P03 | Carnitine | 2 | 0.336 | 0.284 | 0.382 | 0.227 | 0.466 | 0.423 | 0.423 | 0.368 |
| | Metabolism | | | | | | | | | |
| P04 | Creatine | 2 | 0.000 | 0.003 | 0.0001 | 0.000 | 0.000 | 0.0001 | 0.0001 | 0.000 |
| | Metabolism | | | | | | | | | |
| P05 | Fatty Acid | 2 | 0.002 | 0.065 | 0.001 | 0.006 | 0.001 | 0.000 | 0.000 | 0.001 |
| | Metabolism (also | | | | | | | | | |
| | BCAA Metabolism) | | | | | | | | | |
| P06 | Fatty Acid | 8 | 0.005 | 0.050 | 0.002 | 0.085 | 0.000 | 0.002 | 0.002 | 0.004 |
| | Metabolism(Acyl | | | | | | | | | |
| | Carnitine) | | | | | | | | | |
| P07 | Fatty Acid, | 2 | 0.801 | 0.802 | 0.789 | 0.558 | 0.825 | 0.856 | 0.856 | 0.817 |
| | Dicarboxylate | | | | | | | | | |
| P08 | Fatty Acid, | 2 | 0.086 | 0.078 | 0.086 | 0.078 | 0.143 | 0.074 | 0.074 | 0.074 |
| | Monohydroxy | | | | | | | | | |
| P09 | Food | 6 | 0.046 | 0.123 | 0.021 | 0.255 | 0.036 | 0.010 | 0.010 | 0.028 |
| | Compound/Plant | | | | | | | | | |
| P10 | Fructose, Mannose | 3 | <0.0001 | 0.228 | <0.0001 | 0.001 | 0.000 | 0.039 | 0.037 | <0.0001 |
| | and Galactose | | | | | | | | | |
| | Metabolism | | | | | | | | | |
| P11 | Gamma-glutamyl | 7 | 0.041 | 0.028 | 0.074 | 0.036 | 0.292 | 0.058 | 0.058 | 0.046 |
| | Amino Acid | | | | | | | | | |
| P12 | Glutamate | 3 | 0.270 | 0.238 | 0.267 | 0.346 | 0.209 | 0.194 | 0.194 | 0.303 |
| | Metabolism | | | | | | | | | |
| P13 | Glycerolipid | 2 | 0.045 | 0.021 | 0.083 | 0.019 | 0.050 | 0.030 | 0.030 | 0.040 |
| | Metabolism | | | | | | | | | |
| P14 | Glycine, Serine | 5 | <0.0001 | 0.007 | <0.0001 | 0.000 | 0.000 | <0.0001 | <0.0001 | <0.0001 |
| | and Threonine | | | | | | | | | |
| | Metabolism | | | | | | | | | |
| P15 | Glycolysis, | 5 | 0.000 | 0.002 | <0.0001 | 0.000 | 0.001 | 0.028 | 0.028 | 0.000 |
| | Gluconeogenesis, | | | | | | | | | |
| | and Pyruvate | | | | | | | | | |
| | Metabolism | | | | | | | | | |
| P16 | Hemoglobin and | 5 | 0.050 | 0.049 | 0.036 | 0.669 | 0.000 | 0.014 | 0.014 | 0.053 |
| | Porphyrin | | | | | | | | | |
| | Metabolism | | | | | | | | | |
| P17 | Leucine, | 13 | <0.0001 | 0.000 | 0.000 | 0.001 | 0.000 | <0.0001 | <0.0001 | <0.0001 |
| | Isoleucine and | | | | | | | | | |
| | Valine | | | | | | | | | |
| | Metabolism | | | | | | | | | |
| P18 | Long Chain | 11 | 0.005 | 0.060 | 0.002 | 0.009 | 0.000 | 0.011 | 0.011 | 0.005 |
| | Fatty Acid | | | | | | | | | |
| P19 | Lysine | 4 | 0.511 | 0.470 | 0.578 | 0.758 | 0.464 | 0.325 | 0.325 | 0.540 |
| | Metabolism | | | | | | | | | |
| P20 | Lysolipid | 24 | 0.000 | 0.001 | 0.000 | 0.001 | 0.000 | 0.000 | 0.000 | 0.000 |
| P21 | Medium Chain | 7 | 0.020 | 0.033 | 0.017 | 0.021 | 0.015 | 0.043 | 0.044 | 0.028 |
| | Fatty Acid | | | | | | | | | |
| P22 | Methionine, | 5 | <0.0001 | 0.014 | <0.0001 | 0.000 | 0.000 | <0.0001 | <0.0001 | <0.0001 |
| | Cysteine, SAM | | | | | | | | | |
| | and Taurine | | | | | | | | | |
| | Metabolism | | | | | | | | | |
| P23 | Monoacylglycerol | 2 | 0.051 | 0.041 | 0.043 | 0.040 | 0.085 | 0.106 | 0.106 | 0.058 |
| P24 | Nicotinate and | 2 | <0.0001 | 0.110 | <0.0001 | 0.004 | 0.000 | <0.0001 | <0.0001 | <0.0001 |
| | Nicotinamide | | | | | | | | | |
| | Metabolism | | | | | | | | | |
| P25 | Phenylalanine | 8 | 0.000 | 0.047 | <0.0001 | 0.729 | 0.000 | 0.002 | 0.002 | 0.000 |
| | and Tyrosine | | | | | | | | | |
| | Metabolism | | | | | | | | | |
| P26 | Phospholipid | 2 | 0.006 | 0.029 | 0.004 | 0.006 | 0.006 | 0.002 | 0.002 | 0.006 |
| | Metabolism | | | | | | | | | |
| P27 | Polypeptide | 3 | 0.004 | 0.030 | 0.002 | 0.647 | 0.000 | 0.013 | 0.013 | 0.005 |
| P28 | Polyunsaturated | 10 | 0.006 | 0.051 | 0.003 | 0.011 | 0.000 | 0.009 | 0.009 | 0.006 |
| | Fatty Acid | | | | | | | | | |
| | (n3 and n6) | | | | | | | | | |
| P29 | Primary Bile Acid | 3 | 0.818 | 0.838 | 0.870 | 0.743 | 0.785 | 0.830 | 0.830 | 0.856 |
| | Metabolism | | | | | | | | | |
| P30 | Purine Metabolism, | 3 | <0.0001 | 0.012 | <0.0001 | 0.002 | 0.000 | 0.030 | 0.030 | <0.0001 |
| | (Hypo)Xanthine/ | | | | | | | | | |
| | Inosine containing | | | | | | | | | |
| P31 | Purine Metabolism, | 2 | 0.048 | 0.022 | 0.086 | 0.022 | 0.070 | 0.118 | 0.118 | 0.062 |
| | Adenine containing | | | | | | | | | |
| P32 | Pyrimidine | 2 | 0.486 | 0.478 | 0.440 | 0.333 | 0.499 | 0.361 | 0.361 | 0.486 |
| | Metabolism, Uracil | | | | | | | | | |
| | containing | | | | | | | | | |
| P33 | Secondary Bile | 6 | 0.360 | 0.336 | 0.271 | 0.310 | 0.366 | 0.353 | 0.353 | 0.361 |
| | Acid Metabolism | | | | | | | | | |
| P34 | Steroid | 14 | 0.034 | 0.061 | 0.020 | 0.351 | 0.000 | 0.017 | 0.017 | 0.029 |
| P35 | Sterol | 3 | 0.393 | 0.353 | 0.328 | 0.189 | 0.393 | 0.129 | 0.129 | 0.360 |
| P36 | TCA Cycle | 4 | 0.002 | <0.0001 | 0.042 | 0.005 | 0.008 | 0.022 | 0.022 | 0.002 |
| P37 | Tryptophan | 8 | 0.008 | 0.064 | 0.002 | 0.032 | 0.001 | 0.014 | 0.014 | 0.004 |
| | Metabolism | | | | | | | | | |
| P38 | Urea cycle; | 9 | 0.060 | 0.064 | 0.032 | 0.047 | 0.180 | 0.111 | 0.111 | 0.058 |
| | Arginine and | | | | | | | | | |
| | Proline | | | | | | | | | |
| | Metabolism | | | | | | | | | |
| P39 | Xanthine | 4 | 0.184 | 0.281 | 0.144 | 0.482 | 0.000 | 0.091 | 0.090 | 0.148 |
| | Metabolism | | | | | | | | | |

### Example 1

### Determining the Significance of Genetic Variants in Subjects of Normal Health: Early Indications of Disease

In another example, WES data of one patient revealed mutations in the genes encoding the proteins procolipase and THAD, which have known associations to type II diabetes. Examination of clinical information on this patient revealed a family history of type II diabetes (father and brother). Metabolomic analysis was performed on a sample from this patient, and the full profile is presented in Table 3. Table 3 includes, for each metabolite, the internal identifier for the biomarker compound in the in-house chemical library of authentic standards (CompID); the biochemical name of the metabolite; the biochemical pathway (super pathway); the biochemical sub pathway; and the Z-score value for the level of the metabolite in the sample.

TABLE 3
Metabolite profile of one exemplary patient

| Comp | | Super | | Z- |
|---|---|---|---|---|
| ID | Biochemical Name | Pathway | Sub Pathway | Score |
| 32338 | glycine | Amino Acid | Glycine, Serine | −1.472 |
| 27710 | N-acetylglycine | | and Threonine | 0.186 |
| 1516 | sarcosine (N-Methylglycine) | | Metabolism | 1.098 |
| 5086 | dimethylglycine | | | −0.071 |
| 3141 | betaine | | | −1.329 |
| 1648 | serine | | | 0.129 |
| 37076 | N-acetylserine | | | 0.779 |
| 1284 | threonine | | | 0.787 |
| 33939 | N-acetylthreonine | | | −0.034 |
| 23642 | homoserine | | | −0.574 |
| 1126 | alanine | | Alanine and | −2.515 |
| 1585 | N-acetylalanine | | Aspartate | 1.191 |
| 15996 | aspartate | | Metabolism | 0.203 |
| 34283 | asparagine | | | −0.681 |
| 22185 | N-acetylaspartate (NAA) | | | 0.278 |
| 57 | glutamate | | Glutamate | 0.178 |
| 53 | glutamine | | Metabolism | 0.687 |
| 32672 | pyroglutamine | | | 0.178 |
| 59 | histidine | | Histidine | 0.547 |
| 33946 | N-acetylhistidine | | Metabolism | 0.002 |
| 30460 | 1-methylhistidine | | | 0.516 |
| 15677 | 3-methylhistidine | | | 0.534 |
| 43256 | N-acetyl-3-methylhistidine | | | 0.894 |
| 43255 | N-acetyl-1-methylhistidine | | | −0.629 |
| 607 | trans-urocanate | | | 0.323 |
| 40730 | imidazole propionate | | | −0.645 |
| 15716 | imidazole lactate | | | 1.929 |
| 1301 | lysine | | Lysine | 0.481 |
| 36752 | N6-acetyllysine | | Metabolism | 2.561 |
| 1498 | N-6-trimethyllysine | | | 1.856 |
| 6146 | 2-aminoadipate | | | 1.463 |
| 35439 | glutarylcarnitine (C5) | | | 0.699 |
| 1444 | pipecolate | | | 0.935 |
| 64 | phenylalanine | | Phenylalanine | 0.509 |
| 33950 | N-acetylphenylalanine | | and Tyrosine | 0.586 |
| 22130 | phenyllactate (PLA) | | Metabolism | 0.356 |
| 15958 | phenylacetate | | | 1.929 |
| 541 | 4-hydroxyphenylacetate | | | 0.939 |
| 35126 | phenylacetylglutamine | | | −0.210 |
| 1299 | tyrosine | | | 0.705 |
| 32390 | N-acetyltyrosine | | | 0.342 |
| 32197 | 3-(4-hydroxyphenyl)lactate | | | 0.819 |
| 32553 | phenol sulfate | | | −0.559 |
| 36103 | p-cresol sulfate | | | −0.562 |
| 36845 | o-cresol sulfate | | | 0.694 |
| 12017 | 3-methoxytyrosine | | | −0.411 |
| 38349 | homovanillate sulfate | | | −0.702 |
| 35635 | 3-(3-hydroxyphenyl)propionate | | | −0.165 |
| 39587 | 3-(4-hydroxyphenyl)propionate | | | −0.406 |
| 15749 | 3-phenylpropionate | | | 0.647 |
| | (hydrocinnamate) | | | |
| 42040 | 5-hydroxymethyl-2-furoic acid | | | −1.053 |
| 54 | tryptophan | | Tryptophan | 1.020 |
| 33959 | N-acetyltryptophan | | Metabolism | 1.270 |
| 18349 | indolelactate | | | 0.331 |
| 27513 | indoleacetate | | | −0.712 |
| 32405 | indolepropionate | | | −1.012 |
| 27672 | 3-indoxyl sulfate | | | −1.156 |
| 15140 | kynurenine | | | −0.778 |
| 1417 | kynurenate | | | −1.112 |
| 437 | 5-hydroxyindoleacetate | | | −1.731 |
| 2342 | serotonin (5HT) | | | −0.531 |
| 34402 | indolebutyrate | | | −1.005 |
| 42087 | indoleacetylglutamine | | | −0.789 |
| 37097 | tryptophan betaine | | | 0.400 |
| 32675 | C-glycosyltryptophan | | | 0.006 |
| 60 | leucine | | Leucine, | 0.996 |
| 1587 | N-acetylleucine | | Isoleucine and | 1.169 |
| 22116 | 4-methyl-2-oxopentanoate | | Valine | 1.437 |
| 34732 | isovalerate | | Metabolism | 1.170 |
| 35107 | isovalerylglycine | | (BCAA | 0.098 |
| 34407 | isovalerylcarnitine | | Metabolism) | 0.591 |
| 12129 | beta-hydroxyisovalerate | | | 2.114 |
| 35433 | beta-hydroxyisovaleroylcarnitine | | | 0.091 |
| 37060 | 3-methylglutarylcarnitine (C6) | | | 0.950 |
| 33937 | alpha-hydroxyisovalerate | | | 0.790 |
| 1125 | isoleucine | | | 1.079 |
| 33967 | N-acetylisoleucine | | | 1.622 |
| 15676 | 3-methyl-2-oxovalerate | | | 1.667 |
| 35431 | 2-methylbutyrylcarnitine (C5) | | | 0.638 |
| 35428 | tiglyl carnitine | | | 1.455 |
| 1598 | tigloylglycine | | | 1.148 |
| 32397 | 3-hydroxy-2-ethylpropionate | | | −0.008 |
| 1649 | valine | | | 1.480 |
| 1591 | N-acetylvaline | | | 2.787 |
| 21047 | 3-methyl-2-oxobutyrate | | | 1.732 |
| 33441 | isobutyrylcarnitine | | | 0.848 |
| 1549 | 3-hydroxyisobutyrate | | | 3.501 |
| 22132 | alpha-hydroxyisocaproate | | | 0.008 |
| 1302 | methionine | | Methionine | 0.905 |
| 1589 | N-acetylmethionine | | Cysteine, SAM | 1.243 |
| 2829 | N-formylmethionine | | and Taurine | 1.264 |
| 15948 | S-adenosylhomocysteine (SAH) | | Metabolism | 0.741 |
| 42107 | alpha-ketobutyrate | | | 1.602 |
| 32348 | 2-aminobutyrate | | | 1.693 |
| 21044 | 2-hydroxybutyrate (AHB) | | | 3.086 |
| 31453 | cysteine | | | −0.326 |
| 39512 | cystine | | | −0.654 |
| 39592 | S-methylcysteine | | | −0.058 |
| 2125 | taurine | | | 0.068 |
| 1638 | arginine | | Urea cycle; | 1.587 |
| 1670 | urea | | Arginine and | 0.671 |
| 1493 | ornithine | | Proline | −1.817 |
| 1898 | proline | | Metabolism | −2.075 |
| 2132 | citrulline | | | −0.103 |
| 22137 | homoarginine | | | 0.439 |
| 22138 | homocitrulline | | | 1.434 |
| 36808 | dimethylarginine (SDMA + ADMA) | | | −1.612 |
| 33953 | N-acetylarginine | | | −0.414 |
| 43249 | N-delta-acetylornithine | | | 0.991 |
| 43591 | N2,N5-diacetylornithine | | | −0.532 |
| 37431 | N-methyl proline | | | −1.502 |
| 1366 | trans-4-hydroxyproline | | | 0.287 |
| 35127 | pro-hydroxy-pro | | | 0.692 |
| 27718 | creatine | | Creatine | 1.027 |
| 513 | creatinine | | Metabolism | 0.415 |
| 43258 | acisoga | | Polyamine | −0.484 |
| 1419 | 5-methylthioadenosine (MTA) | | Metabolism | 1.834 |
| 1558 | 4-acetamidobutanoate | | | −0.786 |
| 15681 | 4-guanidinobutanoate | | Guanidino and | −1.881 |
| | | | Acetamido | |
| | | | Metabolism | |
| 38783 | glutathione, oxidized (GSSG) | | Glutathione | −1.288 |
| 35159 | cysteine-glutathione disulfide | | Metabolism | −1.022 |
| 18368 | cys-gly, oxidized | | | −0.675 |
| 1494 | 5-oxoproline | | | −1.097 |
| 37063 | gamma-glutamylalanine | Peptide | Gamma- | −0.625 |
| 36738 | gamma-glutamylglutamate | | glutamyl Amino | 0.191 |
| 2730 | gamma-glutamylglutamine | | Acid | 1.011 |
| 34456 | gamma-glutamylisoleucine | | | 0.825 |
| 18369 | gamma-glutamylleucine | | | 1.192 |
| 33934 | gamma-glutamyllysine | | | 0.886 |
| 37539 | gamma-glutamylmethionine | | | 0.973 |
| 33422 | gamma-glutamylphenylalanine | | | 0.412 |
| 33947 | gamma-glutamyltryptophan | | | 1.461 |
| 2734 | gamma-glutamyltyrosine | | | 0.771 |
| 32393 | gamma-glutamylvaline | | | 1.232 |
| 43488 | N-acetylcarnosine | | Dipeptide | −0.855 |
| 15747 | anserine | | Derivative | −0.023 |
| 37093 | alanylleucine | | Dipeptide | −1.195 |
| 42980 | asparagylleucine | | | 0.698 |
| 40068 | aspartylleucine | | | 0.969 |
| 22175 | aspartylphenylalanine | | | −0.024 |
| 37077 | cyclo(gly-pro) | | | 0.738 |
| 37104 | cyclo(leu-pro) | | | 1.373 |
| 34398 | glycylleucine | | | −0.890 |
| 42027 | histidylalanine | | | 3.619 |
| 42084 | histidylphenylalanine | | | 1.474 |
| 40046 | isoleucylalanine | | | −1.699 |
| 42982 | isoleucylaspartate | | | −1.662 |
| 40057 | isoleucylglutamate | | | −1.342 |
| 40019 | isoleucylglutamine | | | −1.225 |
| 40008 | isoleucylglycine | | | −2.014 |
| 36761 | isoleucylisoleucine | | | −1.663 |
| 36760 | isoleucylleucine | | | −1.157 |
| 40067 | isoleucylphenylalanine | | | −1.740 |
| 42968 | isoleucylthreonine | | | −1.039 |
| 40049 | isoleucylvaline | | | 1.907 |
| 40010 | leucylalanine | | | 0.543 |
| 40052 | leucylasparagine | | | 0.667 |
| 40053 | leucylaspartate | | | 0.311 |
| 40021 | leucylglutamate | | | −0.408 |
| 40045 | leucylglycine | | | −0.689 |
| 40077 | leucylhistidine | | | −1.521 |
| 36756 | leucylleucine | | | 0.157 |
| 40026 | leucylphenylalanine | | | 4.080 |
| 40685 | methionylalanine | | | 2.524 |
| 41374 | phenylalanylalanine | | | −1.585 |
| 41432 | phenylalanylglutamate | | | 0.858 |
| 41370 | phenylalanylglycine | | | 0.692 |
| 40192 | phenylalanylleucine | | | −0.116 |
| 38150 | phenylalanylphenylalanine | | | 1.353 |
| 41377 | phenylalanyltryptophan | | | 0.172 |
| 41393 | phenylalanylvaline | | | −1.024 |
| 40684 | prolylphenylalanine | | | −0.679 |
| 22194 | pyroglutamylglutamine | | | −0.085 |
| 31522 | pyroglutamylglycine | | | −0.370 |
| 32394 | pyroglutamylvaline | | | 0.807 |
| 40066 | serylleucine | | | −0.670 |
| 42077 | seryltyrosine | | | 2.625 |
| 40051 | threonylleucine | | | 0.473 |
| 31530 | threonylphenylalanine | | | 0.598 |
| 40661 | tryptophylasparagine | | | 3.932 |
| 41401 | tryptophylglutamate | | | 0.001 |
| 41399 | tryptophylphenylalanine | | | 0.358 |
| 42953 | tyrosylglutamate | | | −0.853 |
| 42079 | valylglutamine | | | −1.140 |
| 40475 | valylglycine | | | −0.833 |
| 39994 | valylleucine | | | 1.429 |
| 22154 | bradykinin | | Polypeptide | 2.348 |
| 33962 | bradykinin, hydroxy-pro(3) | | | 1.813 |
| 34420 | bradykinin, des-arg(9) | | | 4.002 |
| 32836 | HWESASXX | | | 3.612 |
| 33964 | HWESASLLR | | | 2.534 |
| 20675 | 1,5-anhydroglucitol (1,5-AG) | Carbohydrate | Glycolysis, | −0.666 |
| 20488 | glucose | | Gluconeogenesis, | 0.760 |
| 1414 | 3-phosphoglycerate | | and Pyruvate | −0.786 |
| 599 | pyruvate | | Metabolism | 0.106 |
| 527 | lactate | | | −1.309 |
| 1572 | glycerate | | | −1.106 |
| 15772 | ribitol | | Pentose | −0.053 |
| 35638 | xylonate | | Metabolism | 0.634 |
| 15835 | xylose | | | −0.025 |
| 4966 | xylitol | | | 1.263 |
| 575 | arabinose | | | 0.641 |
| 35854 | threitol | | | −0.850 |
| 38075 | arabitol | | | −0.021 |
| 15821 | fucose | | | −0.822 |
| 15806 | maltose | | Glycogen | 0.444 |
| | | | Metabolism | |
| 577 | fructose | | Fructose, | −1.221 |
| 15053 | sorbitol | | Mannose and | −0.872 |
| 584 | mannose | | Galactose | 1.565 |
| 15335 | mannitol | | Metabolism | 0.161 |
| 40480 | methyl-beta-glucopyranoside | | | 0.479 |
| 15443 | glucuronate | | Aminosugar | 0.704 |
| 33477 | erythronate | | Metabolism | −1.305 |
| 37427 | erythrulose | | Advanced | 1.099 |
| | | | Glycation End- | |
| | | | product | |
| 1564 | citrate | Energy | TCA Cycle | 1.429 |
| 33453 | alpha-ketoglutarate | | | 0.307 |
| 37058 | succinylcarnitine | | | 0.469 |
| 1437 | succinate | | | −0.063 |
| 1303 | malate | | | 0.430 |
| 15488 | acetylphosphate | | Oxidative | 1.019 |
| 11438 | phosphate | | Phosphorylation | 0.117 |
| 33443 | valerate | Lipid | Short Chain | 0.382 |
| | | | Fatty Acid | |
| 32489 | caproate (6:0) | | Medium Chain | −0.840 |
| 1644 | heptanoate (7:0) | | Fatty Acid | −0.150 |
| 32492 | caprylate (8:0) | | | −0.594 |
| 12035 | pelargonate (9:0) | | | 0.244 |
| 1642 | caprate (10:0) | | | −0.290 |
| 32497 | 10-undecenoate (11:1n1) | | | 0.460 |
| 1645 | laurate (12:0) | | | 0.131 |
| 33968 | 5-dodecenoate (12:1n7) | | | −0.207 |
| 1365 | myristate (14:0) | | Long Chain | 0.711 |
| 32418 | myristoleate (14:1n5) | | Fatty Acid | 0.232 |
| 1361 | pentadecanoate (15:0) | | | 0.618 |
| 1336 | palmitate (16:0) | | | 0.664 |
| 33447 | palmitoleate (16:1n7) | | | −0.196 |
| 1121 | margarate (17:0) | | | 0.587 |
| 33971 | 10-heptadecenoate (17:1n7) | | | 0.241 |
| 1358 | stearate (18:0) | | | 0.924 |
| 1359 | oleate (18:1n9) | | | −0.044 |
| 33970 | cis-vaccenate (18:1n7) | | | 0.120 |
| 1356 | nonadecanoate (19:0) | | | 1.112 |
| 33972 | 10-nonadecenoate (19:1n9) | | | 0.490 |
| 33587 | eicosenoate (20:1n9 or 11) | | | 0.025 |
| 1552 | erucate (22:1n9) | | | 0.360 |
| 33969 | stearidonate (18:4n3) | | Polyunsaturated | −0.983 |
| 18467 | eicosapentaenoate (EPA; 20:5n3) | | Fatty Acid (n3 | −0.440 |
| 32504 | docosapentaenoate (n3 DPA; 22:5n3) | | and n6) | −0.137 |
| 19323 | docosahexaenoate (DHA; 22:6n3) | | | 0.637 |
| 32417 | docosatrienoate (22:3n3) | | | 0.558 |
| 1105 | linoleate (18:2n6) | | | −0.070 |
| 34035 | linolenate [alpha or gamma; (18:3n3 | | | −0.597 |
| | or 6)] | | | |
| 35718 | dihomo-linolenate (20:3n3 or n6) | | | 0.656 |
| 1110 | arachidonate (20:4n6) | | | 1.488 |
| 32980 | adrenate (22:4n6) | | | 1.573 |
| 37478 | docosapentaenoate (n6 DPA; 22:5n6) | | | 2.907 |
| 32415 | docosadienoate (22:2n6) | | | 0.361 |
| 17805 | dihomo-linoleate (20:2n6) | | | 0.214 |
| 38768 | 15-methylpalmitate (isobar with 2- | | Fatty Acid, | 2.121 |
| | methylpalmitate) | | Branched | |
| 38296 | 17-methylstearate | | | 1.759 |
| 37253 | 2-hydroxyglutarate | | Fatty Acid, | 1.130 |
| 15730 | suberate (octanedioate) | | Dicarboxylate | −0.249 |
| 18362 | azelate (nonanedioate) | | | −1.778 |
| 32398 | sebacate (decanedioate) | | | −1.655 |
| 35671 | undecanedioate | | | −1.693 |
| 32388 | dodecanedioate | | | −1.527 |
| 35669 | tetradecanedioate | | | −1.004 |
| 35678 | hexadecanedioate | | | −0.367 |
| 36754 | octadecanedioate | | | 0.528 |
| 31787 | 3-carboxy-4-methyl-5-propyl-2- | | | −0.517 |
| | furanpropanoate (CMPF) | | | |
| 43761 | 2-aminoheptanoate | | Fatty Acid, | −1.202 |
| 43343 | 2-aminooctanoate | | Amino | 0.259 |
| 35482 | 2-methylmalonyl carnitine | | Fatty Acid | −0.489 |
| | | | Synthesis | |
| 32412 | butyrylcarnitine | | Fatty Acid | 1.125 |
| 32452 | propionylcarnitine | | Metabolism | 0.153 |
| | | | (also BCAA | |
| | | | Metabolism) | |
| 32198 | acetylcarnitine | | Fatty Acid | 0.345 |
| 43264 | hydroxybutyrylcarnitine | | Metabolism | 1.679 |
| 34406 | valerylcarnitine | | (Acyl Carnitine) | 1.272 |
| 32328 | hexanoylcarnitine | | | −0.981 |
| 33936 | octanoylcarnitine | | | −1.046 |
| 33941 | decanoylcarnitine | | | −1.234 |
| 38178 | cis-4-decenoyl carnitine | | | −1.108 |
| 34534 | laurylcarnitine | | | −1.409 |
| 33952 | myristoylcarnitine | | | −2.016 |
| 22189 | palmitoylcarnitine | | | −2.146 |
| 34409 | stearoylcarnitine | | | −1.667 |
| 35160 | oleoylcarnitine | | | −2.531 |
| 36747 | deoxycarnitine | | Carnitine | −1.204 |
| 15500 | carnitine | | Metabolism | 0.430 |
| 542 | 3-hydroxybutyrate (BHBA) | | Ketone Bodies | 1.330 |
| 22036 | 2-hydroxyoctanoate | | Fatty Acid, | −1.314 |
| 42489 | 2-hydroxydecanoate | | Monohydroxy | −0.703 |
| 35675 | 2-hydroxypalmitate | | | −0.739 |
| 17945 | 2-hydroxystearate | | | 0.401 |
| 42103 | 3-hydroxypropanoate | | | 0.090 |
| 22001 | 3-hydroxyoctanoate | | | −1.232 |
| 22053 | 3-hydroxydecanoate | | | −1.047 |
| 37752 | 13-HODE + 9-HODE | | | −1.357 |
| 37536 | 12-HETE | | Eicosanoid | −0.350 |
| 38165 | palmitoyl ethanolamide | | Endocannabinoid | 0.024 |
| 39732 | N-oleoyltaurine | | | −0.185 |
| 39730 | N-stearoyltaurine | | | 1.084 |
| 39835 | N-palmitoyltaurine | | | −2.193 |
| 19934 | myo-inositol | | Inositol | −0.448 |
| 37112 | chiro-inositol | | Metabolism | −2.107 |
| 32379 | scyllo-inositol | | | −0.073 |
| 15506 | choline | | Phospholipid | 0.272 |
| 34396 | choline phosphate | | Metabolism | 0.045 |
| 15990 | glycerophosphorylcholine (GPC) | | | −1.112 |
| 12102 | phosphoethanolamine | | | 0.849 |
| 35626 | 2-myristoylglycerophosphocholine | | Lysolipid | −2.069 |
| 37418 | 1- | | | −1.781 |
| | pentadecanoylglycerophosphocholine | | | |
| | (15:0) | | | |
| 33955 | 1-palmitoylglycerophosphocholine | | | −2.570 |
| | (16:0) | | | |
| 35253 | 2-palmitoylglycerophosphocholine | | | −2.243 |
| 33230 | 1- | | | −3.479 |
| | palmitoleoylglycerophosphocholine | | | |
| | (16:1) | | | |
| 35819 | 2- | | | −3.215 |
| | palmitoleoylglycerophosphocholine | | | |
| 33957 | 1-margaroylglycerophosphocholine | | | −2.103 |
| | (17:0) | | | |
| 33961 | 1-stearoylglycerophosphocholine | | | −2.744 |
| | (18:0) | | | |
| 35255 | 2-stearoylglycerophosphocholine | | | −3.104 |
| 33960 | 1-oleoylglycerophosphocholine | | | −3.593 |
| | (18:1) | | | |
| 35254 | 2-oleoylglycerophosphocholine | | | −2.942 |
| 34419 | 1-linoleoylglycerophosphocholine | | | −3.508 |
| | (18:2n6) | | | |
| 35257 | 2-linoleoylglycerophosphocholine | | | −3.115 |
| 33871 | 1-dihomo- | | | −2.710 |
| | linoleoylglycerophosphocholine | | | |
| | (20:2n6) | | | |
| 35623 | 2-arachidoylglycerophosphocholine | | | −2.435 |
| 33821 | 1- | | | −2.050 |
| | eicosatrienoylglycerophosphocholine | | | |
| | (20:3) | | | |
| 35884 | 2- | | | −1.404 |
| | eicosatrienoylglycerophosphocholine | | | |
| 33228 | 1- | | | −2.111 |
| | arachidonoylglycerophosphocholine | | | |
| | (20:4n6) | | | |
| 35256 | 2- | | | −1.925 |
| | arachidonoylglycerophosphocholine | | | |
| 37231 | 1- | | | −3.140 |
| | docosapentaenoylglycerophosphocholine | | | |
| | (22:5n3) | | | |
| 33822 | 1- | | | −1.891 |
| | docosahexaenoylglycerophosphocholine | | | |
| | (22:6n3) | | | |
| 35883 | 2- | | | −2.026 |
| | docosahexaenoylglycerophosphocholine | | | |
| 39270 | 1-palmitoylplasmenylethanolamine | | | −0.119 |
| 39271 | 1-stearoylplasmenylethanolamine | | | −2.162 |
| 35631 | 1- | | | −1.025 |
| | palmitoylglycerophosphoethanolamine | | | |
| 35688 | 2- | | | −0.720 |
| | palmitoylglycerophosphoethanolamine | | | |
| 37419 | 1- | | | −0.017 |
| | margaroylglycerophosphoethanolamine | | | |
| 34416 | 1- | | | −1.327 |
| | stearoylglycerophosphoethanolamine | | | |
| 41220 | 2- | | | −1.949 |
| | stearoylglycerophosphoethanolamine | | | |
| 35628 | 1- | | | −2.788 |
| | oleoylglycerophosphoethanolamine | | | |
| 35687 | 2- | | | −2.590 |
| | oleoylglycerophosphoethanolamine | | | |
| 34565 | 1- | | | −1.264 |
| | palmitoleoylglycerophosphoethanolamine | | | |
| 32635 | 1- | | | −2.841 |
| | linoleoylglycerophosphoethanolamine | | | |
| 36593 | 2- | | | −2.647 |
| | linoleoylglycerophosphoethanolamine | | | |
| 35186 | 1- | | | −1.206 |
| | arachidonoylglycerophosphoethanolamine | | | |
| 32815 | 2- | | | −1.877 |
| | arachidonoylglycerophosphoethanolamine | | | |
| 34258 | 2- | | | −1.346 |
| | docosahexaenoylglycerophosphoethanolamine | | | |
| 43254 | 2- | | | −0.810 |
| | eicosapentaenoylglycerophosphoethanolamine | | | |
| 35305 | 1-palmitoylglycerophosphoinositol | | | 2.386 |
| 19324 | 1-stearoylglycerophosphoinositol | | | 1.580 |
| 39223 | 2-stearoylglycerophosphoinositol | | | 1.343 |
| 36602 | 1-oleoylglycerophosphoinositol | | | 1.528 |
| 36594 | 1-linoleoylglycerophosphoinositol | | | 1.184 |
| 34214 | 1- | | | 0.744 |
| | arachidonoylglycerophosphoinositol | | | |
| 34437 | 1-stearoylglycerophosphoglycerol | | | −0.382 |
| 15122 | glycerol | | Glycerolipid | −0.970 |
| 15365 | glycerol 3-phosphate (G3P) | | Metabolism | 0.313 |
| 21127 | 1-palmitoylglycerol (1- | | Monoacylglycerol | 0.436 |
| | monopalmitin) | | | |
| 21188 | 1-stearoylglycerol (1-monostearin) | | | −0.442 |
| 21184 | 1-oleoylglycerol (1-monoolein) | | | −1.296 |
| 27447 | 1-linoleoylglycerol (1-monolinolein) | | | −1.086 |
| 17769 | sphinganine | | Sphingolipid | −1.259 |
| 37506 | palmitoyl sphingomyelin | | Metabolism | 0.153 |
| 19503 | stearoyl sphingomyelin | | | 0.496 |
| 34445 | sphingosine 1-phosphate | | | −2.857 |
| 17747 | sphingosine | | | −1.572 |
| 1518 | squalene | | Sterol | −2.593 |
| 39864 | lathosterol | | | 0.671 |
| 63 | cholesterol | | | 0.472 |
| 35692 | 7-alpha-hydroxycholesterol | | | 0.667 |
| 35092 | 7-beta-hydroxycholesterol | | | −0.480 |
| 36776 | 7-alpha-hydroxy-3-oxo-4- | | | −1.839 |
| | cholestenoate (7-Hoca) | | | |
| 27414 | beta-sitosterol | | | 0.084 |
| 39511 | campesterol | | | 0.037 |
| 38170 | pregnenolone sulfate | | Steroid | −1.803 |
| 37174 | 21-hydroxypregnenolone | | | −1.610 |
| | monosulfate (1) | | | |
| 37173 | 21-hydroxypregnenolone disulfate | | | −1.956 |
| 37482 | 5-pregnen-3b,17-diol-20-one 3- | | | −1.424 |
| | sulfate | | | |
| 37480 | 5alpha-pregnan-3beta-ol,20-one | | | −1.146 |
| | sulfate | | | |
| 37198 | 5alpha-pregnan-3beta,20alpha-diol | | | −0.610 |
| | disulfate | | | |
| 37201 | 5alpha-pregnan-3alpha,20beta-diol | | | −0.604 |
| | disulfate 1 | | | |
| 32562 | pregnen-diol disulfate | | | −1.451 |
| 32619 | pregn steroid monosulfate | | | −2.677 |
| 40708 | pregnanediol-3-glucuronide | | | −1.111 |
| 1712 | cortisol | | | 1.421 |
| 1769 | cortisone | | | 0.593 |
| 32425 | dehydroisoandrosterone sulfate | | | −1.237 |
| | (DHEA-S) | | | |
| 33973 | epiandrosterone sulfate | | | −1.597 |
| 31591 | androsterone sulfate | | | −1.540 |
| 37202 | 4-androsten-3beta,17beta-diol | | | −1.242 |
| | disulfate (1) | | | |
| 37203 | 4-androsten-3beta,17beta-diol | | | −1.445 |
| | disulfate (2) | | | |
| 37186 | 5alpha-androstan-3alpha,17beta-diol | | | −0.592 |
| | monosulfate (1) | | | |
| 37192 | 5alpha-androstan-3beta,17beta-diol | | | −1.259 |
| | monosulfate (2) | | | |
| 37182 | 5alpha-androstan-3alpha,17alpha- | | | −0.920 |
| | diol disulfate | | | |
| 37187 | 5alpha-androstan-3beta,17alpha-diol | | | −0.554 |
| | disulfate | | | |
| 37184 | 5alpha-androstan-3alpha,17beta-diol | | | −0.798 |
| | disulfate | | | |
| 37190 | 5alpha-androstan-3beta,17beta-diol | | | −1.329 |
| | disulfate | | | |
| 32827 | andro steroid monosulfate (1) | | | −1.488 |
| 32792 | andro steroid monosulfate 2 | | | −0.813 |
| 18474 | estrone 3-sulfate | | | −1.292 |
| 19464 | testosterone | | | −0.830 |
| 22842 | cholate | | Primary Bile | −0.645 |
| 18476 | glycocholate | | Acid | −1.032 |
| 18497 | taurocholate | | Metabolism | 0.307 |
| 32346 | glycochenodeoxycholate | | | −2.613 |
| 18494 | taurochenodeoxycholate | | | 0.395 |
| 18477 | glycodeoxycholate | | Secondary Bile | −1.196 |
| 12261 | taurodeoxycholate | | Acid | 0.745 |
| 31912 | glycolithocholate | | Metabolism | −1.048 |
| 32620 | glycolithocholate sulfate | | | 0.668 |
| 36850 | taurolithocholate 3-sulfate | | | 1.385 |
| 34171 | deoxycholate/chenodeoxycholate | | | −1.059 |
| 39379 | glycoursodeoxycholate | | | −2.207 |
| 39378 | tauroursodeoxycholate | | | −0.978 |
| 34093 | hyocholate | | | −1.293 |
| 42574 | glycohyocholate | | | −1.187 |
| 43501 | glycohyodeoxycholate | | | −0.609 |
| 32599 | glycocholenate sulfate | | | −0.059 |
| 32807 | taurocholenate sulfate | | | 1.586 |
| 1123 | inosine | Nucleotide | Purine | −0.187 |
| 3127 | hypoxanthine | | Metabolism, | 0.106 |
| 3147 | xanthine | | (Hypo)Xanthine/ | −0.270 |
| 15136 | xanthosine | | Inosine | −0.057 |
| 1604 | urate | | containing | −0.399 |
| 1107 | allantoin | | | 0.149 |
| 43514 | 9-methyluric acid | | | 0.103 |
| 3108 | adenosine 5′-diphosphate (ADP) | | Purine | 0.212 |
| 32342 | adenosine 5′-monophosphate (AMP) | | Metabolism, | −0.430 |
| 15650 | N1-methyladenosine | | Adenine | 0.444 |
| 37114 | N6-methyladenosine | | containing | 0.776 |
| 35157 | N6-carbamoylthreonyladenosine | | | −0.836 |
| 35114 | 7-methylguanine | | Purine | 0.141 |
| 31609 | N1-methylguanosine | | Metabolism, | 0.383 |
| 35137 | N2,N2-dimethylguanosine | | Guanine | −0.158 |
| 1411 | 2′-deoxyguanosine | | containing | −0.593 |
| 606 | uridine | | Pyrimidine | −0.753 |
| 605 | uracil | | Metabolism, | 0.106 |
| 33442 | pseudouridine | | Uracil | −0.960 |
| 35136 | 5-methyluridine (ribothymidine) | | containing | 0.097 |
| 1559 | 5,6-dihydrouracil | | | −0.465 |
| 3155 | 3-ureidopropionate | | | −0.823 |
| 35838 | beta-alanine | | | −1.026 |
| 37432 | N-acetyl-beta-alanine | | | −3.630 |
| 35130 | N4-acetylcytidine | | Pyrimidine | 1.038 |
| | | | Metabolism, | |
| | | | Cytidine | |
| | | | containing | |
| 1418 | 5,6-dihydrothymine | | Pyrimidine | −0.682 |
| 1566 | 3-aminoisobutyrate | | Metabolism, | 0.026 |
| | | | Thymine | |
| | | | containing | |
| 37070 | methylphosphate | | Purine and | 1.328 |
| | | | Pyrimidine | |
| | | | Metabolism | |
| 594 | nicotinamide | Cofactors | Nicotinate and | −0.631 |
| 27665 | 1-methylnicotinamide | and Vitamins | Nicotinamide | 0.899 |
| 32401 | trigonelline (N′-methylnicotinate) | | Metabolism | 1.340 |
| 40469 | N1-Methyl-2-pyridone-5- | | | −0.159 |
| | carboxamide | | | |
| 1827 | riboflavin (Vitamin B2) | | Riboflavin | −0.476 |
| | | | Metabolism | |
| 1508 | pantothenate | | Pantothenate | −0.678 |
| | | | and CoA | |
| | | | Metabolism | |
| 27738 | threonate | | Ascorbate and | −0.435 |
| 37516 | arabonate | | Aldarate | 1.092 |
| 20694 | oxalate (ethanedioate) | | Metabolism | 0.996 |
| 1561 | alpha-tocopherol | | Tocopherol | 0.364 |
| 35702 | beta-tocopherol | | Metabolism | 0.262 |
| 33418 | delta-tocopherol | | | −0.203 |
| 33420 | gamma-tocopherol | | | 0.098 |
| 37462 | gamma-CEHC | | | −1.653 |
| 42381 | gamma-CEHC glucuronide | | | −0.890 |
| 39346 | alpha-CEHC glucuronide | | | −0.528 |
| 41754 | heme | | Hemoglobin and | −0.727 |
| 32586 | bilirubin (E,E) | | Porphyrin | −1.395 |
| 34106 | bilirubin (E,Z or Z,E) | | Metabolism | −1.090 |
| 2137 | biliverdin | | | −1.636 |
| 32426 | I-urobilinogen | | | −0.610 |
| 40173 | L-urobilin | | | 0.151 |
| 31555 | pyridoxate | | Vitamin B6 | −1.040 |
| | | | Metabolism | |
| 15753 | hippurate | Xenobiotics | Benzoate | 0.146 |
| 18281 | 2-hydroxyhippurate (salicylurate) | | Metabolism | −0.900 |
| 39600 | 3-hydroxyhippurate | | | −0.281 |
| 35527 | 4-hydroxyhippurate | | | −1.198 |
| 15778 | benzoate | | | −0.488 |
| 35320 | catechol sulfate | | | −0.102 |
| 42496 | O-methylcatechol sulfate | | | −0.228 |
| 42494 | 3-methyl catechol sulfate (1) | | | 1.035 |
| 42495 | 3-methyl catechol sulfate (2) | | | 1.354 |
| 42493 | 4-methylcatechol sulfate | | | −1.657 |
| 36848 | 3-ethylphenylsulfate | | | −0.450 |
| 36099 | 4-ethylphenylsulfate | | | −0.613 |
| 36098 | 4-vinylphenol sulfate | | | −1.077 |
| 569 | caffeine | | Xanthine | 0.375 |
| 18254 | paraxanthine | | Metabolism | −0.101 |
| 18392 | theobromine | | | −0.757 |
| 18394 | theophylline | | | 0.315 |
| 34395 | 1-methylurate | | | 0.177 |
| 39598 | 7-methylurate | | | −1.230 |
| 32391 | 1,3-dimethylurate | | | −0.641 |
| 34400 | 1,7-dimethylurate | | | −0.561 |
| 34399 | 3,7-dimethylurate | | | −1.621 |
| 34404 | 1,3,7-trimethylurate | | | −0.632 |
| 34389 | 1-methylxanthine | | | 0.462 |
| 32445 | 3-methylxanthine | | | −0.527 |
| 34390 | 7-methylxanthine | | | −0.975 |
| 34424 | 5-acetylamino-6-amino-3- | | | −0.600 |
| | methyluracil | | | |
| 34401 | 5-acetylamino-6-formylamino-3- | | | −1.124 |
| | methyluracil | | | |
| 553 | cotinine | | Tobacco | −0.212 |
| 38661 | hydroxycotinine | | Metabolite | −0.157 |
| 38662 | cotinine N-oxide | | | −0.228 |
| 43470 | 3-hydroxycotinine glucuronide | | | −1.761 |
| 43400 | 2-piperidinone | | Food | 0.086 |
| 36649 | sucralose | | Compound/ | −0.305 |
| 22177 | levulinate (4-oxovalerate) | | Plant | 0.191 |
| 21049 | 1,6-anhydroglucose | | | 0.085 |
| 38276 | 2,3-dihydroxyisovalerate | | | 2.005 |
| 38100 | betonicine | | | −1.730 |
| 587 | gluconate | | | −0.014 |
| 38637 | cinnamoylglycine | | | 1.051 |
| 40481 | dihydroferulic acid | | | −0.883 |
| 41948 | equol glucuronide | | | −0.258 |
| 40478 | equol sulfate | | | −0.310 |
| 37459 | ergothioneine | | | −1.718 |
| 20699 | erythritol | | | 0.267 |
| 33009 | homostachydrine | | | 2.234 |
| 22114 | indoleacrylate | | | 0.287 |
| 1584 | methyl indole-3-acetate | | | −0.905 |
| 31536 | N-(2-furoyl)glycine | | | 1.590 |
| 21182 | naringenin | | | −0.081 |
| 33935 | piperine | | | 0.428 |
| 18335 | quinate | | | 0.777 |
| 21151 | saccharin | | | −0.952 |
| 34384 | stachydrine | | | −2.532 |
| 15336 | tartarate | | | 0.812 |
| 33173 | 2-hydroxyacetaminophen sulfate | | Drug | −0.473 |
| 33178 | 2-methoxyacetaminophen sulfate | | | −0.296 |
| 34365 | 3-(cystein-S-yl)acetaminophen | | | −0.265 |
| 18299 | 3-(N-acetyl-L-cystein-S-yl)acetaminophen | | | −0.196 |
| 37475 | 4-acetaminophen sulfate | | | −0.709 |
| 12032 | 4-acetamidophenol | | | −0.914 |
| 33423 | p-acetamidophenylglucuronide | | | −0.244 |
| 33384 | salicyluric glucuronide | | | −0.748 |
| 38326 | ibuprofen acyl glucuronide | | | −0.301 |
| 17799 | ibuprofen | | | 0.113 |
| 43330 | 2-hydroxyibuprofen | | | 0.291 |
| 43333 | carboxyibuprofen | | | −0.532 |
| 43496 | 3-hydroxyquinine | | | −0.320 |
| 22115 | 4-acetylphenol sulfate | | | 0.633 |
| 43231 | 6-oxopiperidine-2-carboxylic acid | | | 0.815 |
| 38599 | celecoxib | | | 0.056 |
| 34346 | desmethylnaproxen sulfate | | | −0.436 |
| 43334 | O-desmethylvenlafaxine | | | 0.018 |
| 40459 | escitalopram | | | −0.190 |
| 42021 | fexofenadine | | | −0.853 |
| 43009 | furosemide | | | −1.607 |
| 39625 | hydrochlorothiazide | | | −0.246 |
| 35322 | hydroquinone sulfate | | | −0.841 |
| 43580 | hydroxypioglitazone (M-IV) | | | −0.954 |
| 43579 | ketopioglitazone | | | −1.558 |
| 39972 | metformin | | | −0.904 |
| 18037 | metoprolol | | | −0.148 |
| 34109 | metoprolol acid metabolite | | | −0.229 |
| 12122 | naproxen | | | −0.351 |
| 21320 | ofloxacin | | | −0.276 |
| 38600 | omeprazole | | | −0.227 |
| 41725 | oxypurinol | | | −0.153 |
| 38609 | pantoprazole | | | −0.202 |
| 33139 | pioglitazone | | | −0.660 |
| 39586 | pseudoephedrine | | | −0.250 |
| 39767 | quinine | | | −0.388 |
| 1515 | salicylate | | | −0.930 |
| 43335 | warfarin | | | −0.154 |
| 38002 | 1,2-propanediol | | Chemical | −0.194 |
| 39603 | ethyl glucuronide | | | 0.990 |
| 43266 | 2-aminophenol sulfate | | | −0.910 |
| 1554 | 2-ethylhexanoate | | | 0.274 |
| 38314 | dexpanthenol | | | −0.240 |
| 43424 | dimethyl sulfone | | | −0.028 |
| 32511 | EDTA | | | −1.209 |
| 27728 | glycerol 2-phosphate | | | −0.520 |
| 15737 | glycolate (hydroxyacetate) | | | −1.188 |
| 21025 | iminodiacetate (IDA) | | | −0.339 |
| 43265 | phenylcarnitine | | | 0.715 |
| 39760 | 4-oxo-retinoic acid | | | −0.184 |

An example visual display of the biochemical pathways showing the biochemicals detected in the test sample and highlighting those biochemicals that are altered by the presence of the variant in the patient sample is presented in FIG. 4. It can be seen that by using the visual display in FIG. 4 those biochemical pathways affected by the variant can be identified by the presence and size of dark filled circles indicating affected biochemicals. The size of the circle represents the magnitude of the change of the metabolite in the test sample relative to the reference sample. The metabolites that are significantly changed (i.e., elevated or reduced) in the sample appear as larger circles than metabolites with normal levels with the magnitude of the change indicated by the size of the circle.

The effect of the variant on branched chain amino acid metabolism is indicated on the display presented in FIG. 4. The numbers near the circles correspond to individual biochemicals that are altered in the patient sample. An example Concise Report listing the changed metabolites and interpreting the biochemical significance of the changes is presented in Table 4.

As exemplified here, markers associated with diabetes and insulin resistance were identified by the metabolomic analysis of a test sample from this patient. Selected metabolites affected by the variant are displayed in a concise report exemplified in Table 4. These effected biochemicals include elevated α-hydroxybutyrate, decreased 1,5-anhydroglucitol, decreased glycine, and slightly elevated branched chain amino acid metabolites. In addition, increased glucose and 3-hydroxybutyrate (a product of fatty acid β-oxidation and BCAA catabolism) suggested altered energy metabolism consistent with disrupted glycolysis and increased lipolysis. Collectively these biochemical signatures suggested early indications of diabetes, indicating the detrimental effect of the variants.

TABLE 4
Concise report of biochemical alterations in one exemplary patient
Report Title: Subject #123 suspected mutations in the genes encoding the proteins
procolipase and THAD based on WES analysis.

| Super | | | Comp | Z- |
|---|---|---|---|---|
| Pathway | Sub Pathway | Biochemical Name | ID | Score |
| Amino | Glycine, Serine | glycine | 32338 | −1.472 |
| Acid | and Threonine | | | |
| | Metabolism | | | |
| | Leucine, | leucine | 60 | 0.996 |
| | Isoleucine and | N-acetylleucine | 1587 | 1.169 |
| | Valine | 4-methyl-2-oxopentanoate | 22116 | 1.437 |
| | Metabolism | isovalerate | 34732 | 1.170 |
| | (BCAA | isovalerylglycine | 35107 | 0.098 |
| | Metabolism) | isovalerylcarnitine | 34407 | 0.591 |
| | | beta-hydroxyisovalerate | 12129 | 2.114 |
| | | beta-hydroxyisovaleroylcarnitine | 35433 | 0.091 |
| | | 3-methylglutarylcarnitine (C6) | 37060 | 0.950 |
| | | alpha-hydroxyisovalerate | 33937 | 0.790 |
| | | isoleucine | 1125 | 1.079 |
| | | N-acetylisoleucine | 33967 | 1.622 |
| | | 3-methyl-2-oxovalerate | 15676 | 1.667 |
| | | 2-methylbutyrylcarnitine (C5) | 35431 | 0.638 |
| | | tiglyl carnitine | 35428 | 1.455 |
| | | tigloylglycine | 1598 | 1.148 |
| | | 3-hydroxy-2-ethylpropionate | 32397 | −0.008 |
| | | valine | 1649 | 1.480 |
| | | N-acetylvaline | 1591 | 2.787 |
| | | 3-methyl-2-oxobutyrate | 21047 | 1.732 |
| | | isobutyrylcarnitine | 33441 | 0.848 |
| | | 3-hydroxyisobutyrate | 1549 | 3.501 |
| | | alpha-hydroxyisocaproate | 22132 | 0.008 |
| | Methionine, | 2-hydroxybutyrate (AHB) | 21044 | 3.086 |
| | Cysteine, SAM | | | |
| | and Taurine | | | |
| | Metabolism | | | |
| Carbohydrate | Glycolysis, | 1,5-anhydroglucitol (1,5-AG) | 20675 | −0.666 |
| | Gluconeogenesis, | glucose | 20488 | 0.760 |
| | and Pyruvate | | | |
| | Metabolism | | | |
| Lipid | Ketone Bodies | 3-hydroxybutyrate (BHBA) | 542 | 1.330 |
| | Lysolipid | 2-myristoylglycerophosphocholine | 35626 | −2.069 |
| | | 1-pentadecanoylglycerophosphocholine | 37418 | −1.781 |
| | | (15:0) | | |
| | | 1-palmitoylglycerophosphocholine (16:0) | 33955 | −2.570 |
| | | 2-palmitoylglycerophosphocholine | 35253 | −2.243 |
| | | 1-palmitoleoylglycerophosphocholine | 33230 | −3.479 |
| | | (16:1) | | |
| | | 2-palmitoleoylglycerophosphocholine | 35819 | −3.215 |
| | | 1-margaroylglycerophosphocholine (17:0) | 33957 | −2.103 |
| | | 1-stearoylglycerophosphocholine (18:0) | 33961 | −2.744 |
| | | 2-stearoylglycerophosphocholine | 35255 | −3.104 |
| | | 1-oleoylglycerophosphocholine (18:1) | 33960 | −3.593 |
| | | 2-oleoylglycerophosphocholine | 35254 | −2.942 |
| | | 1-linoleoylglycerophosphocholine (18:2n6) | 34419 | −3.508 |
| | | 2-linoleoylglycerophosphocholine | 35257 | −3.115 |
| | | 1-dihomo-linoleoylglycerophosphocholine | 33871 | −2.710 |
| | | (20:2n6) | | |
| | | 2-arachidoylglycerophosphocholine | 35623 | −2.435 |
| | | 1-eicosatrienoylglycerophosphocholine | 33821 | −2.050 |
| | | (20:3) | | |
| | | 1-arachidonoylglycerophosphocholine | 33228 | −2.111 |
| | | (20:4n6) | | |
| | | 2-arachidonoylglycerophosphocholine | 35256 | −1.925 |
| | | 1-docosapentaenoylglycerophosphocholine | 37231 | −3.140 |
| | | (22:5n3) | | |
| | | 1-docosahexaenoylglycerophosphocholine | 33822 | −1.891 |
| | | (22:6n3) | | |
| | | 2-docosahexaenoylglycerophosphocholine | 35883 | −2.026 |
| | | 1-stearoylplasmenylethanolamine | 39271 | −2.162 |
| | | 2-stearoylglycerophosphoethanolamine | 41220 | −1.949 |
| | | 1-oleoylglycerophosphoethanolamine | 35628 | −2.788 |
| | | 2-oleoylglycerophosphoethanolamine | 35687 | −2.590 |
| | | 1-linoleoylglycerophosphoethanolamine | 32635 | −2.841 |
| | | 2-linoleoylglycerophosphoethanolamine | 36593 | −2.647 |
| | | 2-arachidonoylglycerophosphoethanolamine | 32815 | −1.877 |
| | | 1-palmitoylglycerophosphoinositol | 35305 | 2.386 |
| | | 1-stearoylglycerophosphoinositol | 19324 | 1.580 |
| | | 1-oleoylglycerophosphoinositol | 36602 | 1.528 |

Interpretation: Metabolomic analysis identified markers associated with diabetes and insulin resistance, including elevated α-hydroxybutyrate, decreased 1,5-anhydroglucitol, decreased glycine, and slightly elevated branched chain amino acid metabolites. In addition, increased glucose and 3-hydroxybutyrate (a product of fatty acid β-oxidation and BCAA catabolism) suggested altered energy metabolism consistent, with disrupted glycolysis and increased lipolysis. Collectively, these biochemical signatures suggest early indications of diabetes.

For another patient, WES showed variants on two diabetes risk alleles, MAPK81P1 (p.D386E) and MC4R (pI251L). Similar alterations in diabetes and insulin resistance-associated metabolite markers and biochemical pathways were seen in this patient. Further, a recent targeted metabolic panel showed fasting blood glucose for this patient in the prediabetic range.

### Example 2

### Variant Analysis: Variants Determined to be Benign

In one example, the methods described herein were useful to determine the importance of base-pair changes detected using whole exome sequencing (WES) and aided in diagnosis (i.e., to ‘rule-in’ or ‘rule-out’ a disorder) of patients. For example, the results of the methods described herein ruled out the presence of a disorder in a patient for whom a variant of unknown significance (VUS) based on WES was reported and in so doing determined that the variant did not have a detrimental effect. Such variants are reclassified from VUS to “Benign” or “Neutral”

In one example, a VUS [c.673G>T(p.G225W)] was reported within GLYCTK, the gene affected in glyceric aciduria. However, using the methods described herein, the levels of glycerate in this patient were determined to be normal. The variant did not have a detrimental effect and was determined to be neutral.

In another example, in a patient with a VUS [c.730G>A(p.G244R)] in SLC25A15 , which is the gene affected in hyperornithinemia-hyperammonemia-homocitrullinemia syndrome, normal levels of ornithine, glutamine, and homocitrulline were determined, thereby ruling out the disorder. The variant did not have a detrimental effect and was considered to be neutral.

In another example, a VUS was detected in GLDC [c.718A>G(pT240A)], the gene affected in glycine encephalopathy. Based on normal levels of the metabolite glycine, the VUS was determined to be neutral.

In another example, the VUS [c.1222C>T(p.R408W)] was detected in PAH, the gene affected in phenylketonuria. The levels of phenylalanine in that patient were measured to be normal, and the VUS was determined to be neutral.

In another example, the VUS [c.1669G>C(p.E557Q)] was detected in POLG, the gene affected in mitochondrial depletion syndrome. However, the level of the biochemical lactate was normal, and the VUS was determined to be neutral.

### Example 3

### Variant Analysis: Variants Determined to be Pathogenic/Detrimental

In a further example, the results of the methods described herein helped support the pathogenicity of molecular results.

For example, WES results for one patient revealed a heterozygous VUS [c.455G>A(p.G152D)] in SARDH, which is the gene deficient in sarcosinemia. Using the methods described herein, significant elevations of choline, betaine, dimethylglycine, and sarcosine were determined. These elevated levels are consistent with sarcosinemia, a metabolic disorder for which the existence of clinical symptoms is debated. Based on the results of the analysis it was determined that the variant is pathogenic.

In another patient, a VUS [c.1903G>T(p.V635F)] was reported in LRPPRC, the gene affected in Leigh syndrome. Elevated levels of lactate were measured for this patient, which is consistent with a diagnosis of Leigh syndrome, indicating that the VUS should be categorized as a variant that is deleterious.

In another patient, a VUS [c.2846A>T(p.D949V] was reported in DPYD, the gene affected in 5-fluorouracil toxicity. Elevated levels of uracil were measured for this patient, which is consistent with a diagnosis of 5-fluorouracil toxicity. The results indicated that the VUS should be classified as a deleterious variant

In another example, a mutation in GAA, the gene that encodes alpha-glucosidase was reported in a patient. Mutations in GAA have been identified in people diagnosed with Pompe disease. Elevated levels of maltotetraose, maltotriose, and maltose were measured for this patient, which are consistent with a diagnosis of Pompe disease, indicating that the mutation should be classified as a deleterious variant.

In another patient, a mutation was reported in ADSL, the gene that encodes adenylosuccinate lysase and is affected in ADSL deficiency. An elevated level of N6-succinyladenosine was measured for this patient, which is consistent with a diagnosis of ADSL deficiency. The results indicated that the variant should be classified as deleterious.

In another example, a mutation in PEX1, the gene that encodes peroxisomal biogenesis factor was reported in a patient. Mutations in PEX1 have been identified in people diagnosed with peroxisomal biogenesis disorders/Zellweger syndrome spectrum disorders (PBD/ZSS). Elevated levels of pipecolate and reduced levels of plasmalogens (e.g., 1-(1-enyl-palmitoyl)-2-oleoyl-GPC (P-16:0/18:1), 1-(1-enyl-palmitoyl)-2-myristoyl-GPC (P-16:0/14:0), 1-(1-enyl-palmitoyl)-2-arachidonoyl-GPE (P-16:0/20:4), 1-(1-enyl-stearoyl)-2-arachidonoyl-GPE (P-18:0/20:4), 1-(1-enyl-palmitoyl)-2-palmitoyl-GPC (P-16:0/16:0), 1-(1-enyl-palmitoyl)-2-arachidonoyl-GPC (P-16:0/20:4), 1-(1-enyl-stearoyl)-2-arachidonoyl-GPC (P-18:0/20:4), 1-(1-enyl-palmitoyl)-2-palmitoleoyl-GPC (P-16:0/16:1)) were measured for this patient, which is consistent with a diagnosis of PBD/ZSS. The results indicated that the variant should be classified as deleterious.

1-47. (canceled)

48. A system for the determining the effect of genetic variants, comprising:
a collection of data describing a plurality of biochemical pathways, each biochemical pathway description specifying small molecule compounds associated with the biochemical pathway;
a data acquisition apparatus, the data acquisition apparatus processing a test sample following the identification of a genetic variant in a subject in order to determine the effect of the genetic variant, the processing of the test sample generating result data indicating a condition of a biochemical compound in the test sample relative to a control for each of a plurality of biochemical compounds; and
an analysis facility executing on a computing device to identify one or more biochemical pathways affected by the indicated variant for at least some of the plurality of biochemical compounds by associating at least some of the plurality of biochemical compounds to the one or more biochemical pathways using the collection of data describing the plurality of biochemical pathways, wherein the one or more identified biochemical pathways comprise only a portion of the plurality of biochemical pathways described by the collection of data, the analysis facility used to store information regarding said identified biochemical pathway and the biochemical compound or biochemical compounds associated with the identified biochemical pathway for each identified biochemical pathway.

49. The system of claim 48 wherein the analysis facility generates a score ranking the at least some of the plurality of biochemical compounds based on a change in the one or more identified biochemical pathways affected by the indicated genetic variants.

50. The system of claim 48, wherein the analysis facility is used in identifying at least one expected effect in the one or more biochemical pathways affected by the indicated genetic variant for at least some of the plurality of biochemical compounds.

51. The system of claim 48, wherein the analysis facility is used in identifying at least one unexpected effect in the one or more biochemical pathways affected by the indicated genetic variant for at least some of the plurality of biochemical compounds.

52. The system of claim 51 wherein the unexpected affect is a negative unexpected affect.

53. The system of claim 48, further comprising a display device, the display device displaying a listing of the one or more biochemical pathways affected by the indicated genetic variant for at least some of the plurality of small molecule compounds.

54. The system of claim 53, wherein the listing identifies at least one changed metabolite in the one or more biochemical pathways affected by the indicated genetic variant for at least some of the plurality of small molecule compounds.

55. The system of claim 48, wherein the data acquisition apparatus performs at least one of liquid chromatography, gas chromatography, mass spectrometry, liquid chromatography-mass spectrometry or gas chromatography-mass spectrometry on the test sample.

56. The system of claim 48, wherein the analysis facility is used to interpret a meaning of a change in the one or more biochemical pathways affected by the indicated genetic variant for at least some of the plurality of biochemical compounds, wherein the interpretation is based on a pre-defined set of criteria.

57. The system of claim 56, wherein the analysis facility is configured such that interpreting a meaning of a change in the one or more biochemical pathways is performed programmatically without user assistance for at least some of the plurality of small molecule compounds, wherein the interpretation is based on a pre-defined set of criteria.

58. The system of claim 56, wherein the interpretation is displayed to a user.

59. The system of claim 56, wherein the interpretation is stored.

60. The system of claim 48, wherein the collection of data is stored in a database.

61. A medium for use with a computing device, the medium holding computer-executable instructions for identifying the effect of a genetic variant, the instructions comprising:
instructions for providing, in a computing device, a collection of data describing a plurality of biochemical pathways, each biochemical pathway description specifying small molecule compounds associated with said biochemical pathway;
instructions for performing an analysis on a sample from a subject having a genetic variant to determine the effect of a genetic variant in a subject;
instructions for processing the test sample to acquire result data indicating the effect of one or more genetic variants, the result data indicating a condition of a biochemical compound in the presence of said genetic variant relative to a control not having said genetic variant for each of a plurality of biochemical compounds;
instructions for identifying one or more biochemical pathways affected by the indicated genetic variant for at least some of the plurality of biochemical compounds, the identifying including associating at least some of the plurality of biochemical compounds to the one or more biochemical pathways using the collection of data describing the plurality of biochemical pathways, wherein the identified biochemical pathway or pathways comprise only a portion of the plurality of biochemical pathways described by the collection of data; and
instructions for storing information regarding said identified biochemical pathway and a biochemical compound or biochemical compounds mapped to the identified biochemical pathway for each identified biochemical pathway.

62. The medium of claim 61, wherein the identification identifies at least one expected effect in the one or more biochemical pathways affected by the indicated genetic variant for at least some of the plurality of small molecule compounds.

63. The medium of claim 61, wherein the identification identifies at least one unexpected effect in the at least one or more biochemical pathways affected by the indicated genetic variant for at least some of the plurality of small molecule compounds.

64. The medium of claim 61 wherein the unexpected effect is a negative unexpected affect.

65. The medium of claim 61, wherein said instructions further comprise instructions for displaying a listing of the one or more biochemical pathways affected by the indicated genetic variant for at least some of the plurality of small molecule compounds.

66. The medium of claim 61, wherein the listing identifies at least one changed metabolite in the one or more biochemical pathways affected by the indicated genetic variant for at least some of the plurality of small molecule compounds.

67. The medium of claim 61, wherein the instructions for processing further comprise instructions for performing at least one of liquid chromatography, gas chromatography, mass spectrometry, liquid chromatography-mass spectrometry or gas chromatography-mass spectrometry on the test sample.

68. The medium of claim 61, wherein the instructions further comprise instructions for interpreting a meaning of a change in the one or more biochemical pathways affected by the indicated genetic variant for at least some of the plurality of small molecule compounds, the interpretation based on a pre-defined set of criteria.

69. The medium of claim 68 wherein the instructions further comprise instructions for displaying the interpretation to a user.

70. The medium of claim 68, wherein the instructions further comprise instructions for storing the interpretation of the meaning of the change in the one or more biochemical pathways affected by the indicated genetic variant for at least some of the plurality of small molecule compounds.

71. The medium of claim 68, wherein the collection of data describing a plurality of biochemical pathways is stored in a database.

72. The medium of claim 68, wherein the one or more biochemical pathways are identified programmatically without user assistance.

73. A method for determining the effect of a genetic variant on an individual subject, the method comprising identifying biochemical pathways affected by said genetic variant, wherein identifying comprises:
obtaining a small molecule profile of a biological sample from the subject having said genetic variant;
comparing said small molecule profile to a standard small molecule profile;
identifying biochemical components of said small molecule profile affected by said variant; and
identifying one or more biochemical pathways associated with said identified biochemical components, thus identifying one or more biochemical pathways affected by said genetic variant; and
storing information regarding each identified biochemical pathway and an identified biochemical component or identified biochemical components mapped to the identified biochemical pathway for each identified biochemical pathway.

74. The method of claim 73, wherein said genetic variant is a single nucleotide polymorphism.

75. The method of claim 73, wherein said genetic variant is a structural genetic variant.

76. The method of claim 73, wherein said structural genetic variant is selected from the group comprising insertions, deletions, rearrangements, copy number variants, and transpositions.

77. The method of claim 73, wherein said small molecule profiles are obtained using one or more of the following: HPLC, TLC, electrochemical analysis, mass spectroscopy, refractive index spectroscopy (RI), Ultra-Violet spectroscopy (UV), fluorescent analysis, radiochemical analysis, Near-InfraRed spectroscopy (Near-IR), Nuclear Magnetic Resonance spectroscopy (NMR), and Light Scattering analysis (LS).

78. The method of claim 73, further comprising using said stored information regarding said identified biochemical pathways to identify the presence or likelihood of a disease or disorder associated with the genetic variant in said subject, thus determining the effect of the genetic variant.
